(19) United States
(12) Patent Application Publication
(10) Pub. No.: US 2024/0180194 A1
(43) Pub. Date: Jun. 6, 2024

(54) PLANT-BASED MEAT REPLICAS AND METHODS FOR PRODUCING THE SAME

(71) Applicant: Sundial Foods, Inc., Albany, CA (US)

(72) Inventors: Siwen DENG, Albany, CA (US); Jessica Schwabach, San Diego, CA (US)

(73) Assignee: Sundial Foods, Inc., Albany, CA (US)

(21) Appl. No.: 18/396,440

(22) Filed: Dec. 26, 2023

Related U.S. Application Data
(63) Continuation of application No. 18/158,177, filed on Jan. 23, 2023, now abandoned.
Application No. 18/158,177 is a continuation of application No. 17/929,199, filed on Sep. 1, 2022, now abandoned.
Application No. 17/929,199 is a continuation of application No. PCT/US2021/020553, filed on Mar. 2, 2021.
(60) Provisional application No. 62/984,657, filed on Mar. 3, 2020.
(60) Provisional application No. 63/047,185, filed on Jul. 1, 2020.

(51) Int. Cl. A23J 3/22; A23L 5/10

(52) U.S. Cl. CPC A23J 3/227; A23L 5/10

(57) ABSTRACT

Provided herein are methods for generating replicas of animal products using plant-based compositions. Methods may include providing a first mixture comprising one or more plant-based materials, processing the first mixture by stretching, folding, or layering to generate a three-dimensional structure, and coating the three-dimensional structure with one or more layers of a second mixture to generate the plant-based meat replica. The one or more layers may be disposed on an external surface of the three-dimensional structure. The three-dimensional structure may replicate a first component of an animal meat and the one or more layers may replicate a second component of an animal meat.

### CROSS-REFERENCE

This application is a continuation of U.S. patent application Ser. No. 18/158,177, filed Jan. 23, 2023, which is a continuation of U.S. patent application Ser. No. 17/929,199, filed Sep. 1, 2022, which is a continuation of International Application No. PCT/US2021/020553, filed Mar. 2, 2021, which claims the benefit of U.S. Provisional Pat. App. No. 62/984,657, filed Mar. 3, 2020, and U.S. Provisional Pat. App. No. 63/047,185, filed Jul. 1, 2020, each of which applications is incorporated by reference herein in its entirety.

### BACKGROUND

Plant-based alternatives are in development for animal-based meat products. Plant-based alternatives can be produced through a variety of processes to mimic taste, texture, appearance, and structure of animal-based meat products. While a plant-based alternative may mimic certain types of taste and texture, matching appearance, structure, and complexity of taste and various textures of an animal-based meat product can be challenging. For example, existing plant-based alternatives can be uniform or homogenous and, thus, appear and feel different from the animal-based meat products they are meant to replace. These factors may detract from the overall experience of consuming plant-based alternatives such that current products do not replicate the experience of eating animal-based meat. Moreover, waste volume and processing energy for producing plant-based alternatives can be cumbersome. Current production processes may lack flexibility in terms of rapid profile adjustment or interchangeability of plant materials. Scaling of production processes of plant-based alternatives can also be challenging, requiring constant recalibration and creating limitations in terms of plant ingredients that may be used or altered.

### SUMMARY

Recognized herein is a need for new and improved plant-based compositions as alternatives for animal-based meat products and improved methods for producing and using the same. The present disclosure provides compositions of plant-based alternatives for animal-based meat products that have, for example, similar physical properties (e.g., structure, shape, density, appearance, complexity, integrity, etc.) and similar sensory properties (e.g., texture, taste, flavor, mouth feel, etc.) to the animal-based meat products that they are intended to replace. Additionally, the plant-based compositions may provide similar physical and organoleptic properties (e.g., fiber structure, chewiness, crunchiness, juiciness, crispiness, etc.) to the animal-based products that are being mimicked. The improved plant-based compositions as alternatives for animal-based meat products include plant-based coatings intended to improve the organoleptic, physical, and aesthetic properties of the plant-based alternative such that its likeness to animal meat is increased. Plant-based coatings for such plant-based alternatives, or even animal-based meat products, are also provided herein. Coatings (e.g., a plant-based “skin,” plant-based “tendon”) may improve flavor (e.g., without any processing, through the cooking process, or through the marinating process), retain moisture, increase water holding capacity, improve juiciness, improve texture (e.g., crunchiness, crispiness, etc.), improve appearance before cooking and after cooking (e.g., browning, grill lines, the Maillard reaction, etc.), improve the complexity and integrity, and also enhance the experience of eating the products (e.g., organoleptic perception, etc.) that they coat. The disclosure also provides methods for producing such compositions and methods for using the same.

Plant material, including leaves, stems, roots, fruits, and seeds from different plant species, and plant fractions, including, for example, protein-enriched and carbohydrate-enriched (e.g., starch-enriched), oil-enriched plant fractions, naturally occurring lipids, and other macro- and micro-molecules from plant materials may produce a plant-based meat product alternative that has a taste, texture, appearance, or structure that mimics an animal-based meat. In some cases, plant-based meat products described herein may comprise plant fractions that are texturally similar to animal-based meat. The textural similarity may result from plant fractions aligning and arranging in a relatively linear fiber formation and organizing into layered bundles of different sizes. The alignment can be achieved using one or more plant fractions from one or more plant materials (e.g., different combinations of protein-enriched fractions and starch-enriched fractions from different legume plants fractions, such as, for example, chickpea and mung bean) in different concentrations, inducing physicochemical changes.

The textural similarity may result from plant fractions aggregating, gelling and depositing into a network formation and binding and adhering to the surfaces or between layers or bundles. The aggregation may be achieved using one or more plant fractions from one or more plant materials (e.g. by varying combinations of protein-enriched and starch-enriched fractions from different plants, such as soybean protein aggregates/networks, soybean protein and mung bean protein aggregates/networks, and rice starch gelling films) in different concentrations, inducing physicochemical changes. The textural similarity may result from plant factions emulsifying, incorporating air, and incorporating flavors into a stable mixture and permeating or adhering to the layers or bundles. The stable mixture may be achieved using one or more plant fractions from one or more plant materials (e.g. different combination of protein-enriched and oil-enriched fractions from different plants, such as, for example, protein-enriched fractions from chickpea and lentil, and oil-enriched fractions from flaxseed) in different concentrations, inducing physicochemical changes. Indeed, compositions, processes, and methods provided herein can provide for alternatives to any type of animal-based meat, including poultry (e.g., chicken, turkey, duck), beef, pork, lamb, veal, fish, shell fish and other types of animal-based meat in fresh or dried format described herein.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

In an aspect, the present disclosure provides a composition, comprising: a first material component configured (i) to replicate or mimic a first component of an animal meat, and (ii) in a three-dimensional structure, wherein the first material component is derived from a plant-based material; and a second material component configured (i) to replicate or mimic a second component of the animal meat, and (ii) as a layer structure, wherein the layer structure is disposed adjacent to at least a portion of the three dimensional structure, and wherein the first material component and the second material component do not include an animal-derived component.

In some embodiments, the first material component comprises substantially aligned fibers. In some embodiments, the composition further comprises one or more of fiber, starch, or fat incorporated between fibers of between bundles of fibers of the substantially aligned fibers. In some embodiments, the fiber, starch, or fat is configured to replicate or mimic muscular tissue, intramuscular tissue, connective tissue, or any combination thereof. In some embodiments, the first material component comprises greater than or equal to about 5% by dry weight protein derived from a pulse or legume. In some embodiments, the first material component further comprises one or more members selected from the group consisting of gluten, grain, oil, and natural flavors. In some embodiments, the layer of the second material component has a thickness from about 0.1 millimeters (mm) to about 10 mm. In some embodiments, the second material component comprises a curd. In some embodiments, the second material component comprises one or more materials selected from the group consisting of a protein-based edible film or coating, a starch-based edible film or coating, a non-starch polysaccharide edible film or coating, a lipid-based edible film or coating, an emulsion and bi-layer edible film or coating, and an edible gel. In some embodiments, the second material component comprises soy or Yuba. In some embodiments, the second material component comprises rice paper.

In some embodiments, the composition further comprises a third material component configured to replicate or mimic bone. In some embodiments, the third material component comprises plant material or plastic. In some embodiments the first component or the second component of the animal meat is intramuscular tissue, connective tissue, cartilaginous tissue, skin, or any combination thereof. In some embodiments, the composition further comprises a plurality of three-dimensional structures, wherein the plurality of three-dimensional structures comprises the three-dimensional structure, and wherein the plurality of three-dimensional structures is at least partially covered by or encapsulated by the second material component. In some embodiments, the first material component comprises substantially aligned fibers configured to replicate or mimic muscle fibers. In some embodiments, the second material component is disposed at least partially internal to the plurality of three-dimensional structures, and wherein the second material component is configured to replicate or mimic intramuscular tissue, connective tissue, or both. In some embodiments, the composition further comprises an additional layer of the second material component disposed on at least a portion of an external surface of the plurality of three-dimensional structures, wherein the additional layer of the second material component is configured to replicate or mimic skin.

In some embodiments, the first material component has a lightness (L*) from about 30 to 70. In some embodiments, the second material component has a lightness (L*) from about 30 to 70. In some embodiments, the second material component has a tensile strength from about 0 0 grams per square millimeter (g/mm²) to about 7 g/mm². In some embodiments, the second material component has a lipid to protein mass ratio from about 0.1 to about 0.6. In some embodiments the second material component has a sugar to protein mass ratio from about 0.1 to about 0.6.

In another aspect, the present disclosure provides a method for producing a food composition, comprising: providing a first mixture and a second mixture, wherein the first mixture is derived from a plant-based material, and wherein the first mixture and the second mixture do not include an animal-derived component; shaping the first mixture into a three dimensional structure such that the first mixture replicates or mimics a first component of an animal meat; and coating at least a portion of the three-dimensional structure with one or more layers of the second mixture to generate a coated three-dimensional structure, wherein the one or more layers coating the three-dimensional structure replicate or mimic a second component of the animal meat.

In some embodiments, the first component or second component of the animal meat is intramuscular tissue, connective tissue, cartilaginous tissue, or any combination thereof. In some embodiments, the one or more layers of the second mixture are adhered to the three-dimensional structure. In some embodiments, the plant-based material comprises a pulse or a legume. In some embodiments, the method further comprises combining a pulse or legume puree with a protein enriched pulse fraction to generate the first mixture. In some embodiments, the protein enriched pulse fraction is formed from dried pulses. In some embodiments, the method further comprises commuting the dried pulses to generate particles of the dried pulses. In some embodiments, prior to providing the first mixture and the second mixture, the particles of the dried pulses are separated by size using air classification. In some embodiments, the method further comprises heat-treating, pressure cooking, steam cooking, or autoclaving the first mixture, the second mixture, or a combination thereof. In some embodiments, shaping the first mixture into the three-dimensional structure comprises generating substantially aligned fibers. In some embodiments, the method further comprises incorporating fiber, starch, or fat between fibers or bundles of fibers of the substantially aligned fibers, the fiber, starch, or fat is configured to replicate or mimic muscular tissue, intramuscular tissue, connective tissue, or any combination thereof. In some embodiments, the first mixture comprises greater than or equal to about 5% by dry weight protein derived from a pulse or a legume. In some embodiments, the method further comprises forming the three-dimensional structure around a first material, wherein the first material replicates or mimics bone. In some embodiments, the first material comprises plant material or plastic. In some embodiments, the coating of the at least the portion of the three-dimensional structure with the second mixture comprises dipping, wrapping, soaking, brushing, spraying, injecting, or any combination thereof.

In some embodiments, the method further comprises baking, frying, marinating, aerating, braising, breading, seasoning, or grilling the first mixture, the second mixture, or any combination thereof to replicate or mimic taste, texture, or physical or organoleptic properties of the animal tissue. In some embodiments, the method further comprises generating a plurality of coated three-dimensional structures comprising the coated three-dimensional structure. In some embodiments, the first mixture comprises aligned fibers that replicant or mimic muscle fibers. In some embodiments, the one or more layers are disposed at least partially internal to the plurality of three-dimensional structures to replicate or mimic intramuscular tissue, connective tissue, or both. In some embodiments, the method further comprises coating at least a portion of the plurality of three-dimensional structures with one or more additional layers of the second mixture to generate a coated plurality of three-dimensional structures. In some embodiments, the method further comprises injecting the second mixture into the plurality of three-dimensional structures to replicate intramuscular tissue, connective tissue, or any combination thereof.

In another aspect, the present disclosure provides a method for producing a food composition, comprising: providing a mixture comprising one or more plant-based materials, wherein the mixture does not include an animal-derived component; and processing the mixture to generate a three-dimensional structure comprising substantially aligned fibers, wherein the processing comprises stretching, folding, or layering the mixture.

In some embodiments, the one or more plant-based materials comprise a pulse puree, legume puree, protein enriched pulse fraction, gluten, or any combination thereof. In some embodiments, wherein the mixture is generated by combining the pulse or the legume puree with the protein enriched pulse fraction. In some embodiments, the protein enriched pulse fraction is formed from dried pulses. In some embodiments, the method further comprises commuting the dried pulses to generate particles of the dried pulses. In some embodiments, prior to providing the mixture, the particles of the dried pulses are separated by size using air classification. In some embodiments, the method further comprises pressure cooking or autoclaving the mixture. In some embodiments, the method further comprising shaping or molding the three-dimensional structure comprising substantially aligned fibers. In some embodiments, the three-dimensional structure comprising substantially aligned fibers is generated by stretching the mixture. In some embodiments, the three-dimensional structure comprising substantially aligned fibers is generated by folding the mixture. In some embodiments, the method further comprises incorporating fiber, starch, or fat between fibers or bundles of fibers of the substantially aligned fibers, the fiber configured to replicate or mimic muscle tissue, intramuscular tissue, connective tissue, or any combination thereof. In some embodiments, the method further comprises injecting the fiber, starch, or fat between the fibers or bundles of fibers to incorporate the fiber, starch or fat into the three-dimensional structure. In some embodiments, the mixture comprises greater than or equal to about 5% by dry weight protein derived from a pulse or a legume. In some embodiments, the method further comprises forming the three-dimensional structure around a first material, wherein the first material replicates or mimics bone. In some embodiments, the first material comprises plant material or plastic. In some embodiments, the method further comprises baking, frying, marinating, aerating, braising, breading, seasoning, or grilling the mixture to replicate or mimic taste, texture, or physical or organoleptic properties of the animal tissue.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1A depicts example texture after steaming, showing pore formation of mung bean and lentil protein aggregates. FIG. 1B depicts an example matrix showing textural differences caused by altering a ratio of protein-enriched and starch-enriched fraction of lentil.

FIG. 2 shows an example plant-based meat composition comprising chickpea plant fractions, gluten, mung bean plant fractions, and black bean plant fractions.

FIG. 3A and FIG. 3B show the fibers of an example plant-based meat composition comprising plant fractions from chickpea, gluten, mung bean and black bean. FIG. 3A shows thicker fiber bundles similar to larger animal muscle, whereas FIG. 3B shows finer fibers.

FIGS. 4A-4F show a force test and textural analyses of example compositions described herein. FIG. 4A shows a cutting force test of various compositions comprising plant fractions from mung bean and black bean (tests 9-17) and mung bean only (tests 18-26). FIG. 4B shows a textural analysis of example compositions comprising different plant fraction combinations (e.g., chickpea and mung bean vs. chickpea-gluten with mung bean and black bean). FIG. 4C shows the texture of example plant-based compositions (e.g., mimicking chicken) with various concentrations of gluten. FIG. 4D shows the meat-like appearance example of plant-based compositions with various concentrations of gluten (e.g., 17%, 23%, 29%) in comparison to chicken. FIG. 4E shows a cutting force test of chicken vs. an example plant-based composition described herein comprising 17% gluten. FIG. 4F shows a force test of an example plant-based composition comprised herein comprising 17% gluten versus an example plant based composition comprised herein comprising 29% gluten with more gluten providing a harder product. FIG. 4G shows a textural analysis of example plant-based compositions with varying concentrations of gluten (e.g., 17%, 23%, 29%) compared to chicken.

FIG. 5A and FIG. 5B show the appearance of an example plant-based meat composition described herein dipped once (FIG. 5A) and twice (FIG. 5B) in a coating described herein.

FIG. 6A and FIG. 6B show the appearance of an example cooked plant-based meat composition described herein.

FIG. 7 shows an example computer system that is programmed or otherwise configured to implement methods provided herein.

FIGS. 8A-8C show an example plant-based composition described herein comprising plant fractions from chickpea, lentil, and gluten.

FIGS. 9A-9D show flowcharts of example processes to produce an example plant-based composition described herein.

FIG. 10 shows an example of dough folding to mimic muscle bundles in a plant-based chicken thigh.

FIGS. 11A-11C show an example plant-based meat composition wrapped in a coating.

FIGS. 12A and 12B show an example of marinating and pan-frying a coated plant-based meat composition.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In certain aspects, the disclosure provides plant-based meat compositions that are, for example, structurally and texturally similar to animal-based meat and meat products. Also described herein are methods of producing and using a plant-based meat composition described herein. Described herein are methods of producing and using a plant-based meat composition that is structurally and texturally similar to animal-based meat and meat products. Also described herein are plant-based coating compositions that mimic or are otherwise similar to animal-based skin. In some embodiments, methods of producing and using plant-based coating compositions are described herein.

### Key Terms and Definitions

As used herein, the term “protein isolate” generally refers to a protein derived from a plant that has been extracted from the plant and purified. A protein isolate may comprise greater than or equal to about 80%, 90%, 95%, or more protein on a dry matter basis.

As used herein, the term “plant fraction” generally refers to a fraction of material that has been enriched to include higher amounts of, for example, protein, starch, or fat via processing of a starting material. Processing may include, for example, soaking, grinding, mixing, air classifying, germination, heating, settling, changing pH, centrifugation, enzyme treatment or any combination thereof.

As used herein, the term “legume” generally refers to a plant from the Fabaceae family. A legume includes the leaves, stem, and pods of the plant. For example, a chickpea pod is a legume.

As used herein, the term “pulse” generally refers to edible seed of a legume. Pulses may include, but are not limited to beans, lentils, and peas.

As used herein, the terms “grain” or “cereal,” which may be used interchangeably, generally refer to the edible seed of a plant from the family Poaceae including, but not limited to, wheat, corn, rice, oat, sorghum, and millet.

As used herein, the term “powder” generally refers to a plant-based material that is ground, pulverized, commuted, or otherwise broken into fine particles.

As used herein, the term “milk” generally refers to a plant-based material that is ground, pulverized, or otherwise broken into fine particles and combined with water to generate a emulsion. The milk may or may not be filtered to remove non-soluble materials. The milk may or may not be combined with a plant-based oil (e.g., sunflower oil) to stabilize the emulsion. A milk may be filtered to remove particulate or non-soluble materials that are greater than or equal to 250 micrometers in diameter. Particulate or non-soluble materials may be removed via sieving, filtration, centrifugation, or any combination thereof.

As used herein, the term “puree” generally refers to a plant-based material that is ground, pulverized, or otherwise broken into fine particles. A puree may or may not include added water. A puree may have a higher concentration, by wet weight, plant material than a milk. A puree may not be processed (e.g., via filtration, centrifugation, etc.) to remove particulate or non-soluble materials.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Plant-Based Compositions

### Plant-Based Meat Compositions

In an aspect, the present disclosure provides for compositions comprising a first material component, a second material component, or both a first material component and second material component. The first material component may be configured to or may otherwise replicate an animal tissue. The first material component may be configured in or otherwise shaped into a three-dimensional (3D) structure. The first material component may be derived from one or more plant-based materials. The second material may be configured to or may otherwise replicate or mimic a feature of animal tissue, for example, skin, muscle tissue, intramuscular tissue, cartilaginous tissue, connective tissue, or any combination thereof. The second material may be configured as or may comprise a layer structure. The layer structure may be disposed adjacent to at least a portion of the 3D structure. For example, the layer structure may be disposed on a surface, a portion of the surface, or internal to the 3D structure. Alternatively, or in addition to, the layered structure may encapsulate the 3D structure or a portion of the 3D structure.

The disclosure provides plant-based compositions that can mimic animal-based meat and meat products (e.g., edible animal tissue), including any portion of such animal-based meat products, including ground meat, meat emulsions, whole cuts of meat, fat, muscle, skin, bone marrow, etc. Non-limiting examples of animal-based meat that plant-based compositions described herein can mimic include chicken, beef, turkey, pork duck, goose, fish tuna, salmon, bacon, lamb, deer, rabbit, elk, Cornish game hen, shrimp, shellfish, mussels, oysters, ham, cured meat products, mutton, pheasant, pigeon, goat, bison, veal, boar, quail, frog, liver, heart, crab, and lobster.

A plant-based composition that mimics animal-based meat and meat products may comprise plant fractions, fat, lipids, macromolecules, micromolecules, or any combination thereof. The interactions between the plant fractions, fat, lipids, macromolecules, micromolecules, or any combination thereof may produce the meat-like appearance, structure, texture, flavor, or any combination thereof of the plant-based composition. The alignment of the plant fractions within the plant-based composition may produce a product that mimics the appearance, structure, texture, flavor, or any combination thereof of animal-based meat, for example, the structure, appearance, texture, or flavor of muscle tissue, intramuscular tissue, cartilaginous tissue, connective tissue, or any combination thereof. For example, the plant fractions may be arranged in relatively linear fibers, which are organized into networks, such as small and large fiber bundles that are adjacently layered. The alignment can be achieved using different combinations and amounts of plant fractions (e.g., legume proteins, such as legume protein-enriched fractions, legume starch, such as legume starch-enriched fractions and cereal proteins, such as gluten).

The characteristics of plant fractions can be quantified using several food-relevant metrics, such as, for example, gelation, foaming, emulsification, or aggregation. Plant fractions (e.g., legume proteins) can be combined to induce fibrilization of the plant proteins while also altering other functionalities, e.g., pore formation, gelation, moisture retention. The fibrilization of the plant fractions may be similar to the fibrilization of animal muscle fibers, animal-based meat or meat products. Plant proteins may or may not be denatured. The plant proteins may be partially denatured. The plant proteins may or may not be plant protein isolate. In an example, the plant proteins are not protein isolates. Fibrillization may be induced by a multi-level process. The plant-based composition may comprise a combination of long and short fibers. The plant-based composition may comprise a combination of thick and thin fibers. Fibers may be combined with other plant-derived plant fraction sources to form a meat-like plant-based composition. The composition may include one or more of fiber, starch, or fat incorporated between fibers or bundles of fibers. The fiber, starch, or fat may be configured to or may replicate or mimic muscular tissue, intramuscular tissue, connective tissue, or any combination thereof.

Plant fractions may comprise any plant-based material. Plant fractions may comprise the edible portion of a legume, such as the pulse, and no other plant-based material. Plant fractions may comprise the edible portion of a cereal grass, such as the grain, and no other plant-based material. Plant fractions may comprise the edible portion of roots and tuber crops, such as the starchy roots and tubers, and no other plant-based material. Plant fractions can be derived from plant products selected from one or more of the following: chickpeas, lentils, mung beans, black beans, peas (e.g., yellow peas and green peas), lima beans, lupin beans, kidney beans, white beans, red beans, fava beans, pinto beans, broad beans, soybeans, wheat, rice, millet, sorghum, corn, oat, barley, potato, and cassava.

Plant fractions may be derived from whole plant materials, chopped plant materials, ground plant materials, pureed plant materials, milk generated from the plant material, or any combination thereof. In an example, plant fractions may derive from whole pulses (e.g., beans), chopped pulses (e.g., beans), ground pulses (e.g., beans), pureed pulses (e.g., beans), a milk generated from pulses (e.g., beans), or any combination thereof. In an example, plant fractions may derive from whole grains, chopped grains, ground grains, pureed grains, a milk generated from grains, or any combination thereof. The plant material (e.g., pulses) may comprise a skin. The plant material (e.g., pulses) may not comprise a skin. The plant material may be soaked in a liquid, such as, for example, water, milk, or juice. Plant fractions can be adjusted, for example through pH and temperature alterations, particle size filtering, particle weight filtering to alter the nutritional content and profile, fiber formation, fiber size, fiber length, fiber strength, pore formation, pore size, number of pores, or texture, flavor, or color of a food product or intermediate used to generate a food product. The composition of the plant fractions may be modified using liquid-liquid extraction, filtration, separation (e.g., gravitational settling or centrifugation), heating, air classification, altering pH, or any combination thereof.

A plant-based milk product, a puree of the plant material, or a powder from ground plant material may be used as the base of a plant-based composition. The plant-based milk product, powder, or puree can derive from at least one, two, three, four, five, or more different plant materials (e.g., pulses and grains). The concentration of plant-based milk product or puree can be adjusted, for example, through altering the ratio of plant material and liquid by weight or by volume. The plant powder may be adjusted for particle size, nutrition content, etc. Furthermore, the plant-based milk product or the puree may be pH adjusted, or subject to temperature alterations (e.g., via heating or cooling).

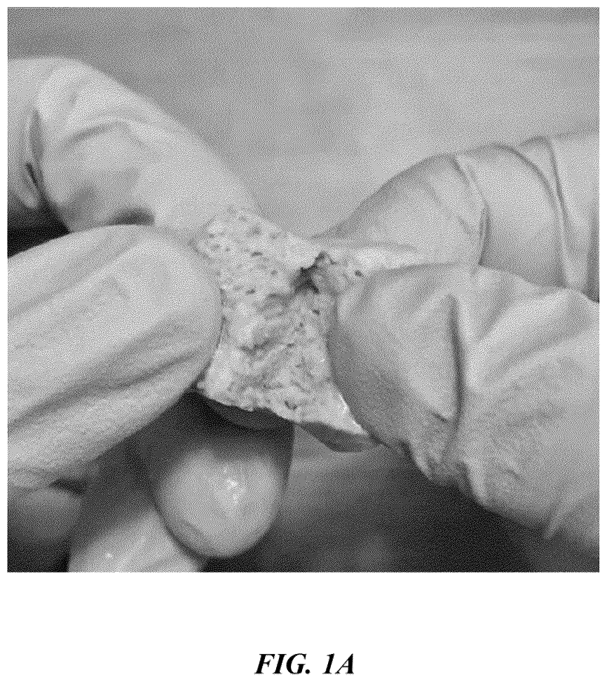

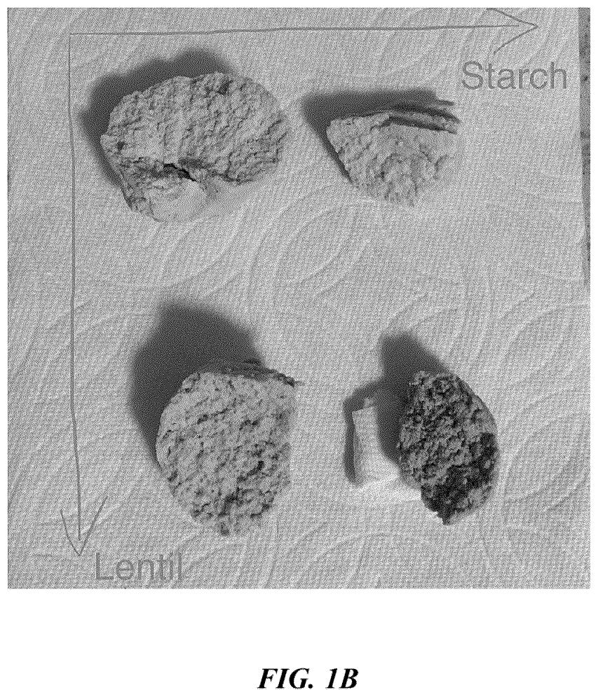

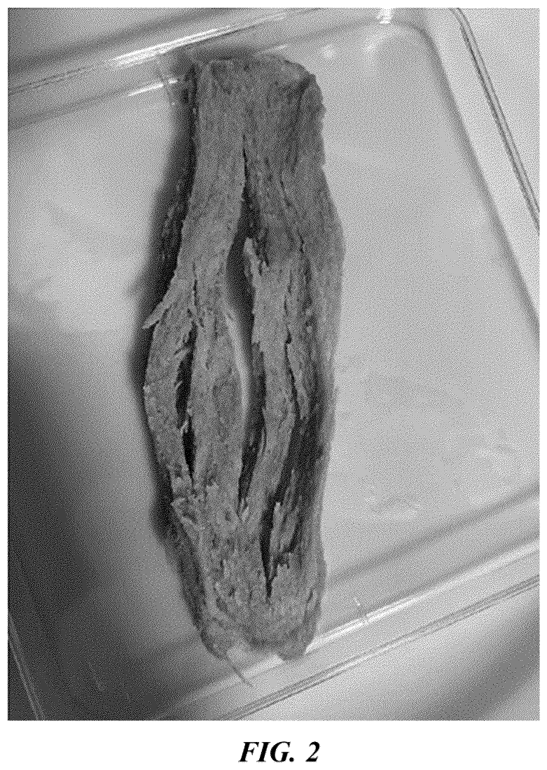

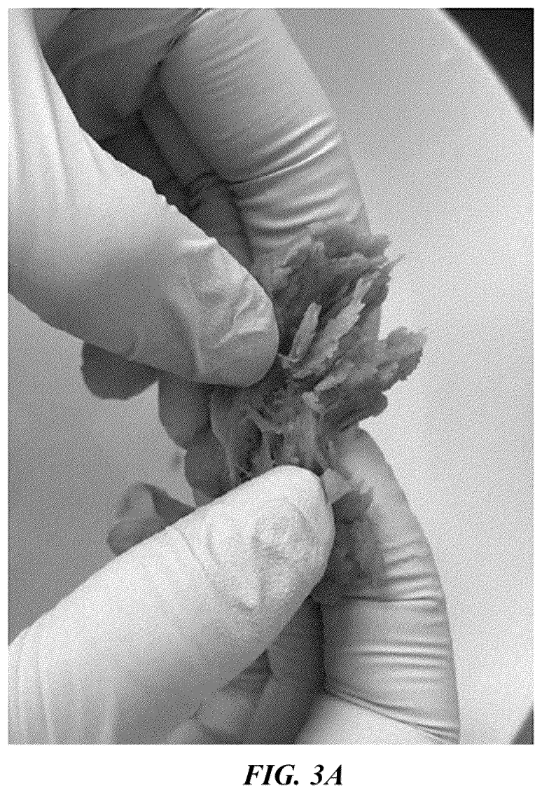

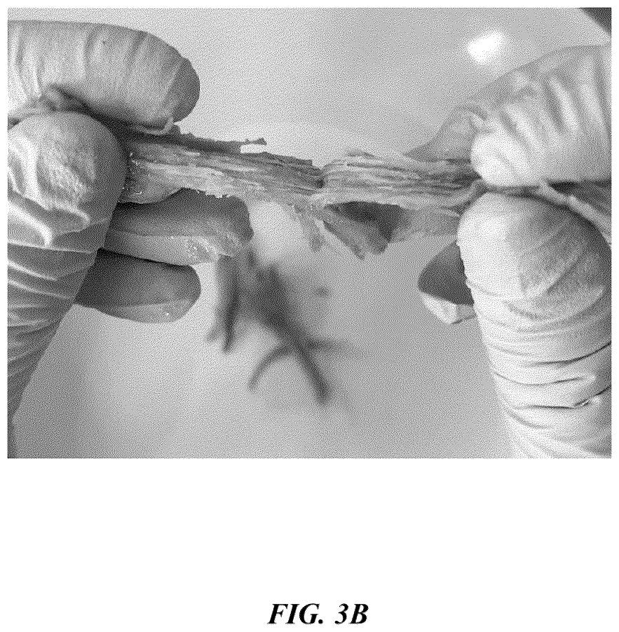

The number of different plant sources and the concentration and the alteration of a plant-based milk product or a puree, and the particle size and the alteration of a powder from ground plant material, in the plant-based composition may change the characteristics (e.g., appearance, maximum shear force, work shear, hardness, crunchiness, crispiness, tack, and stickiness) of the plant-based product. Combinations may comprise, for example, whole chickpea puree with lentil milk, gluten, and flavoring component for a fibrous product. The lentil milk may be a milk that is not been processed to modify the temperature or pH of the milk. Combinations may comprise, for example, chickpea puree with mung bean milk and gluten for a porous product. The mung bean milk may be a milk that is not been processed to modify the temperature or pH of the milk. Combinations may comprise, for example, whole chickpea puree with temperature-adjusted soybean, black bean milk, and gluten for a less porous but softer product. The black bean milk may be a milk that is not processed to modify the temperature or pH of the milk. Combinations may comprise a whole chickpea puree with temperature-adjusted whole mung bean and gluten for a porous but dense product. Combinations may include a whole chickpea puree with black bean milk and temperature-adjusted whole mung bean milk for a porous but less dense product. Lentil and mung bean milk may create large pores and decrease the density of a product. Whole mung bean puree may provide hardness and decrease the elasticity of the fibers. Mung bean combined with black bean milk and a chickpea puree base may create a porous and softer product; black beans may break the stiffness and regularity of mung bean-chickpea protein structures or cages within the product (FIG. 1A and FIG. 1B). Gluten may be added to the plant-based composition. For example, the appearance and texture for a plant-based meat product comprising (i) chickpea, gluten, mung bean, and black bean is depicted in FIG. 2 and (ii) chickpea and gluten in FIG. 3A and FIG. 3B.

The plant-based composition may be generated by combining a plant derived protein fraction, a plant-based milk or puree, gluten, water, oil, flavors, or any combination thereof. The plant-based composition may be an intermediate product that is used to generate a plant-based food product (e.g., plant-based meat product) or the plant-based composition may be the plant-based food product. In an example, the plant-based composition is a dough-like material that is cooked, shaped, molded, stretched, layered, or otherwise processed to form the plant-based food product (e.g., plant-based meat product).

The plant derived protein fraction may be a protein enriched fraction of a plant material. The plant material may be a legume or pulse plant material. The plant derived protein fraction may be generated using liquid-liquid extraction, filtration, separation (e.g., gravitational settling or centrifugation), heating, air classification, altering pH, or any combination thereof. In an example, the plant derived protein fraction is derived using air classification, heating, or both air classification and heating. The plant derived protein fraction may comprise greater than or equal to about 30%, 40%, 50%, 60%, 70%, 80%, or more protein content by dry weight. The plant derived protein fraction may comprise less than or equal to about 80%, 70%, 60%, 50%, 40%, 30%, or less protein content by dry weight. The plant derived protein fraction may comprise from about 20% to 30%, 20% to 40%, 20% to 50%, 20% to 60%, 20% to 70%, 20% to 80%, 30% to 40%, 30% to 50%, 30% to 60%, 30%, to 70%, 30% to 80%, 40%, to 50%, 40% to 60%, 40% to 70%, 40% to 80%, 50% to 60%, 50% to 70%, 50% to 80%, 60%, to 70%, 60% to 80%, or 70% to 80% protein content by dry weight. The plant-based composition may include greater than or equal to about 1%, 5%, 10%, 15%, 20%, 30%, 40%, 50%, or more plant derived protein fraction by dry weight. The plant-based composition may include less than or equal to about 50%, 40%, 30%, 20%, 15%, 10%, 5%, 1%, or less plant derived protein fraction by dry weight. The plant-based composition may include from about 1% to 5%, 1% to 10%, 1% to 15%, 1% to 20%, 1% to 30%, 1% to 40%, 1% to 50%, 5% to 10%, 5% to 15%, 5% to 20%, 5% to 30%, 5% to 40%, 5% to 50%, 10% to 15%, 10% to 20%, 10% to 30%, 10% to 40%, 10% to 50%, 15% to 20%, 15% to 30%, 15% to 40%, 15% to 50%, 20% to 30%, 20% to 40%, 20% to 50%, 30% to 40%, 30% to 50%, or 40% to 50% plant derived protein fraction by dry weight. In an example, the plant-based composition comprises greater than or equal to about 10% plant derived protein fraction by dry weight. In another example, the plant-based composition comprises less than or equal to about 20% plant derived protein by dry weight.

The plant-based composition may include a plant-based milk or puree. The plant-based milk or puree may be derived from a legume or a pulse. The plant-based composition may include greater than or equal to about 1%, 5%, 10%, 15%, 20%, 30%, 40%, 50%, or more plant-based milk or puree by wet weight. The plant-based composition may include less than or equal to about 50%, 40%, 30%, 20%, 15%, 10%, 5%, 1%, or less plant-based milk or puree by wet weight. The plant-based composition may include from about 1% to 5%, 1% to 10%, 1% to 15%, 1% to 20%, 1% to 30%, 1% to 40%, 1% to 50%, 5% to 10%, 5% to 15%, 5% to 20%, 5% to 30%, 5% to 40%, 5% to 50%, 10% to 15%, 10% to 20%, 10% to 30%, 10% to 40%, 10% to 50%, 15% to 20%, 15% to 30%, 15% to 40%, 15% to 50%, 20% to 30%, 20% to 40%, 20% to 50%, 30% to 40%, 30% to 50%, or 40% to 50% plant-based milk or puree by wet weight. In an example, the plant-based composition comprises less than or equal to about 10% plant-based milk or puree by wet weight. In another example, the plant-based composition comprises greater than or equal to about 5% plant-based milk or puree by wet weight.

Characteristics of the plant-based compositions described herein may be altered with the methods and combinations described herein. Characterizations of the plant-based composition may include, for example, appearance, maximum shear force, work shear, hardness, crunchiness, crispiness, tack, stickiness, fiber size, fiber density, fiber strength, fiber bundle size, the number of fiber bundles, the directionality of the fibers, pore size, the relative number of pores, or any combination thereof.

Textures of the plant-based composition described herein that can be modified using methods and combinations described herein include, for example, chewiness, stickiness, hardness, crispness, fibrousness, smoothness, or any combination thereof. Flavor can be controlled or altered with varying levels of ingredients with masking or astringent properties, and by methods, such as, for example heating, rinsing, changing pH, or any combination thereof. Additionally, natural flavors can be incorporated to neutralize flavors or to add an animal meat-like taste. Flavors may include, but are not limited to spices, salts, marinades, juices, nitro flavorings, nutritional yeast, fermented flavoring material, or any combination thereof. The plant-based composition or plant-based food product may comprise less than or equal to about 10%, 9%, 8%, 7%, 6%, 5%, 4%, 3%, 2%, 1%, 0.01%, or less flavoring by dry weight.

The plant-based composition may or may not contain protein isolates. In an example, the plant-based compositions do not contain protein isolates. The plant-based product may be a plant-based meat product and may have a texture similar to animal-based meat. The plant-based meat product can have colors similar to poultry (e.g., chicken, duck, turkey) or red meat (e.g., beef, pork, lamb). Color can be modified by varying the ratios of different ingredients, such as increasing the ratio of a warm-toned milk or puree legume fraction (e.g., derived from lentils) relative to a yellow-toned milk or puree legume fraction (e.g., derived from chickpeas). Color may be modified by a variety of methods, such as emulsification, aeration, heating, rinsing, changing pH, or any combination thereof. Artificial coloration may or may not be added. In an example, artificial coloration may not be added. Artificial coloration may include colors added to the plant-based food product by food safe dyes and synthetic coloring agents. Color may be varied by the addition of plant-based material such as, for example, beet juice, elderberry juice, turmeric, paprika, or red onion. The plant-based composition may have a lightness (L*) that at least partially describes the color space of the plant-based composition. For example, a lightness of zero may be a black plant-based composition and a lightness of 100 may be a diffuse white plant-based composition. The lightness of the plant-based composition may be greater than or equal to about 10, 20, 30, 40, 50, 60, 70, 80, or more. The lightness of the plant-based composition may be less than or equal to about 80, 70, 60, 50, 40, 30, 20, 10, or less. The lightness of the plant-based composition may be from about 10 to 20, 10 to 30, 10 to 40, 10 to 50, 10 to 60, 10 to 70, 10 to 80, 20 to 30, 20 to 40, 20 to 50, 20 to 60, 20 to 70, 20 to 80, 30 to 40, 30 to 50, 30 to 60, 30 to 70, 30 to 80, 40 to 50, 40 to 60, 40 to 70, 40 to 80, 50 to 60, 50 to 70, 50 to 80, 60 to 70, 60 to 80, or 70 to 80. In an example, the lightness of the plant-based composition is from about 30 to 70.

In some cases, plant-based compositions comprise Yuba. Yuba may be a plant-based alternative to animal skin.

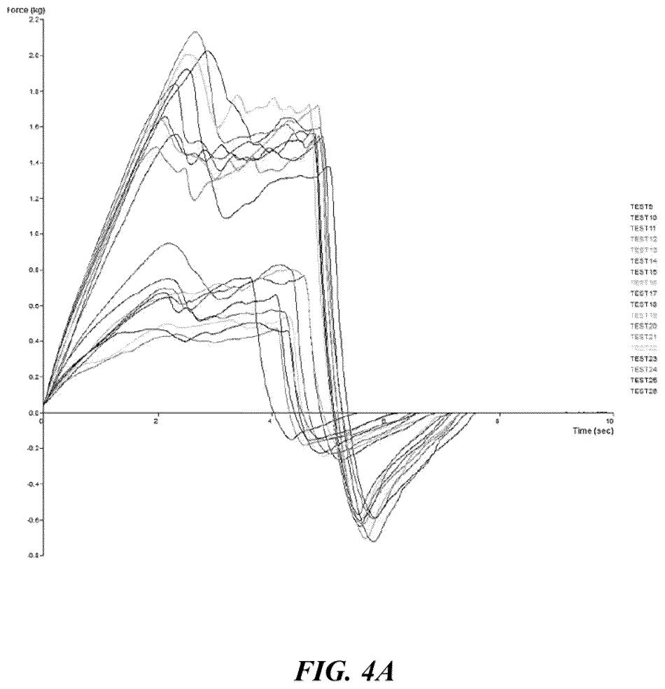

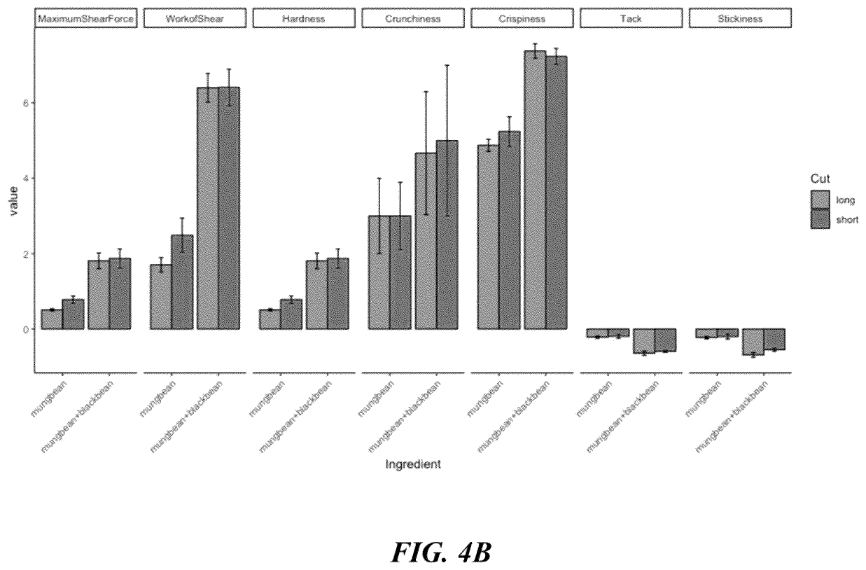

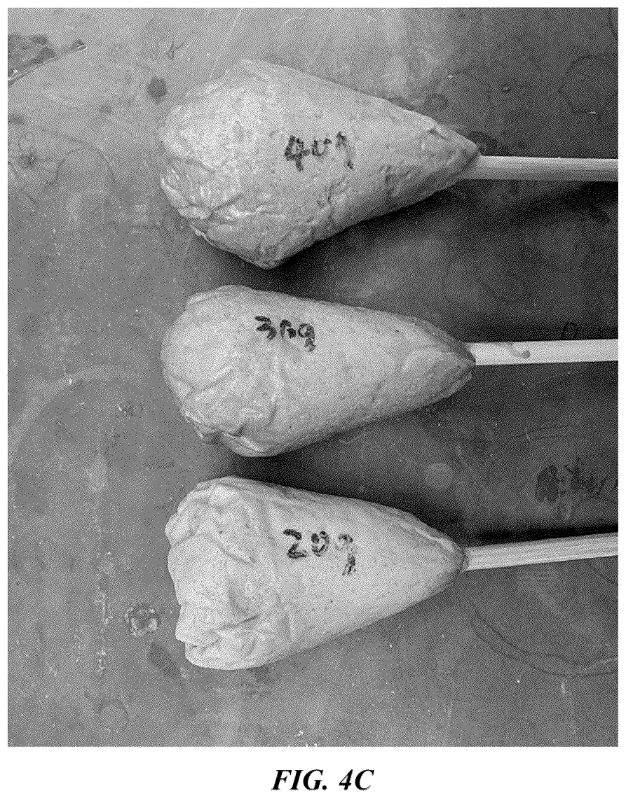

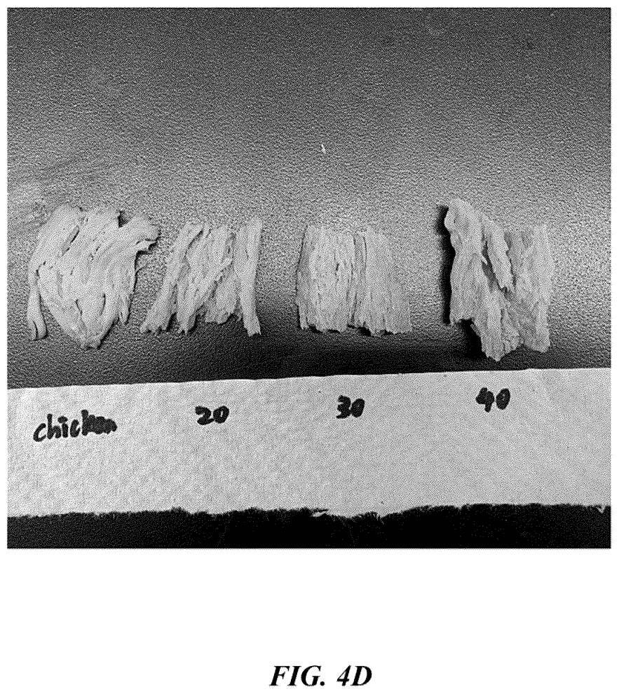

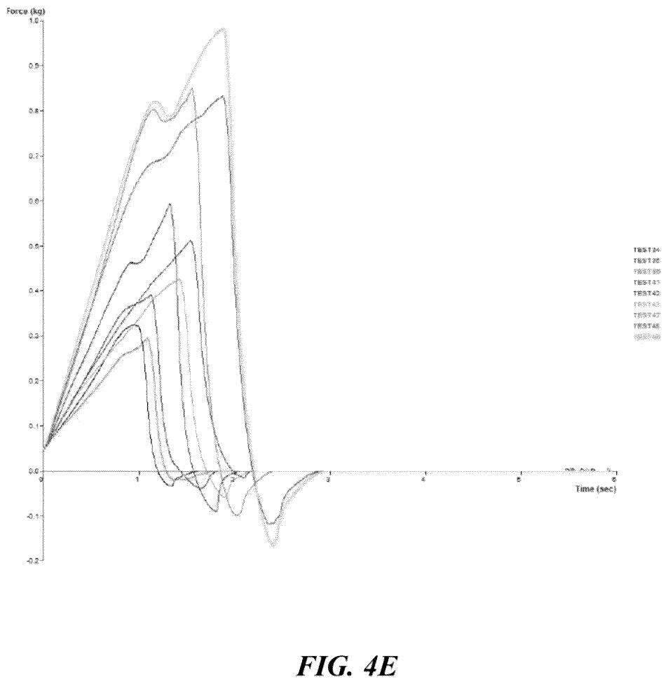

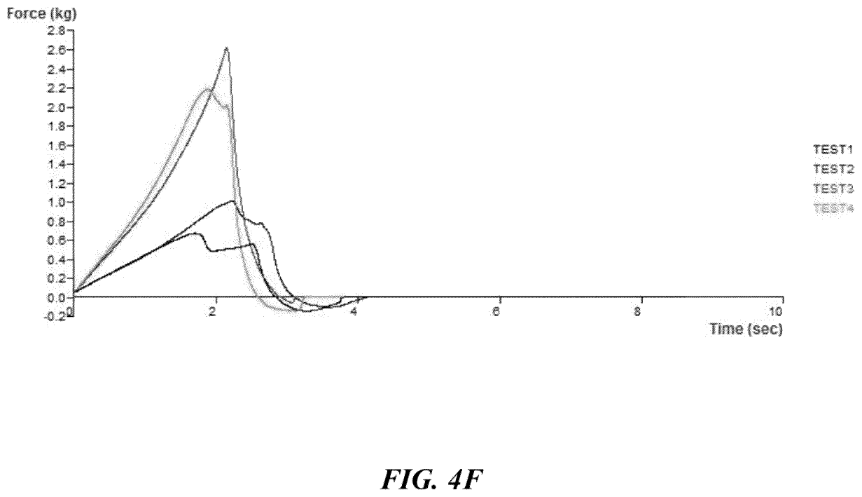

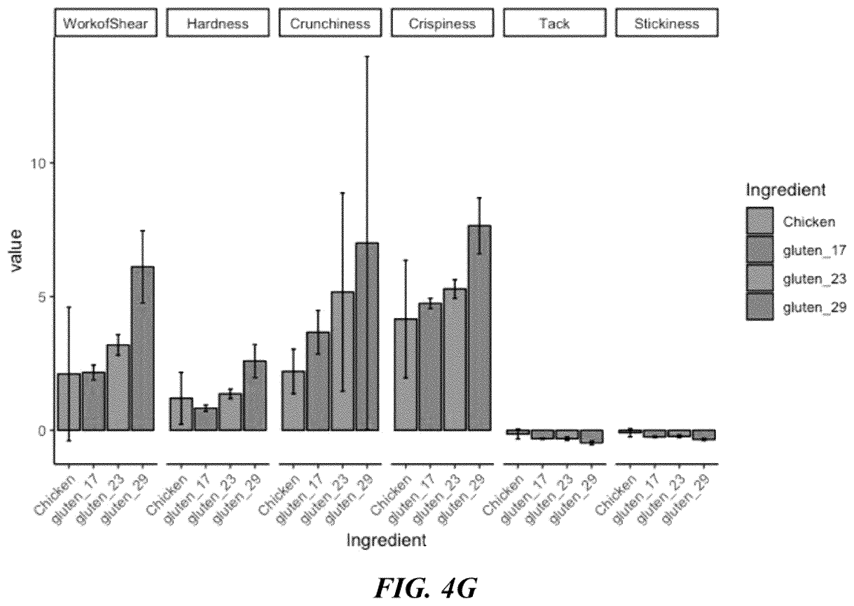

Wheat gluten (e.g., vital wheat gluten) may be added to the plant-based composition. Wheat gluten may be a linker. The proteins of the wheat gluten include, for example, gliadins and glutenins. These two groups of proteins can interact with each other to form a complex, viscoelastic network. These proteins may also interact with plant fractions. The interaction with plant fractions may create fibers and layers of different sizes and elasticities. Gliadins can generate higher viscosities and glutenins can increase the elasticity of the network. Glutenin may induce fiber creation with plant fractions of the plant-based composition described herein. A higher concentration of gliadins than glutenin can minimize the “springiness”, resistance, or other mechanical properties of the plant-based composition described herein (FIGS. 4A-4G).

The plant-based composition (e.g., dough) or plant-based food product (e.g., plant-based meat product) may comprise greater than or equal to about 1%, 5%, 10%, 20%, 30%, 40%, 50%, or more gluten by wet weight. The plant-based composition (e.g., dough) or plant-based food product (e.g., plant-based meat product) may comprise less than or equal to about 50%, 40%, 30%, 20%, 10%, 5%, 1%, or less gluten by wet weight. The plant-based composition (e.g., dough) or plant-based food product (e.g., plant-based meat product) may comprise from about 1% to 5%, 1% to 10%, 1% to 20%, 1% to 30%, 1% to 40%, 1% to 50%, 5% to 10%, 5% to 20%, 5% to 30%, 5% to 40%, 5% to 50%, 10% to 20%, 10% to 30%, 10% to 40%, 10% to 50%, 10% to 30%, 10% to 40%, 10% to 50%, 20% to 30%, 20% to 40%, 20% to 50%, 30% to 40%, 30% to 50%, or 40% to 50% gluten by wet weight. In an example, the plant-based composition (e.g., dough) or plant-based food product (e.g., plant-based meat product) comprises less than or equal to about 10% gluten. The gluten may comprise from about 30% to about 50% gliadins by weight.

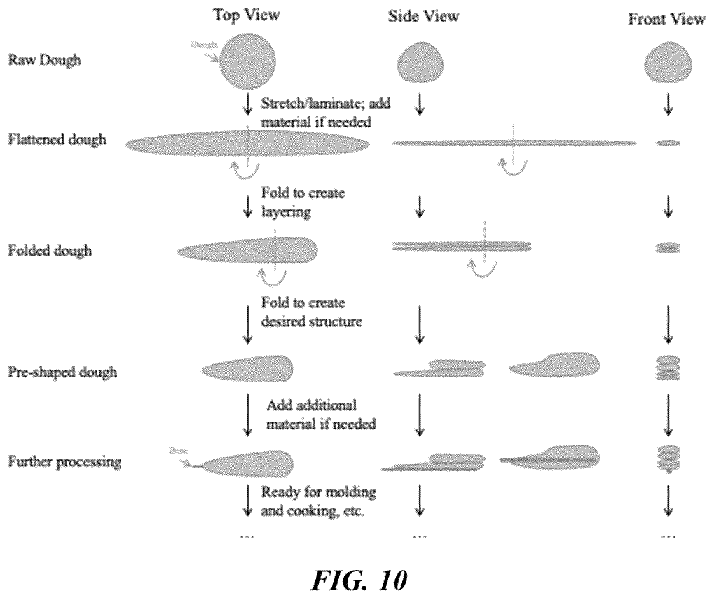

Gluten-containing plant-based compositions may or may not be extrusion-based or seitan-based products. Seitan-based gluten-containing plant-based compositions may have a high water concentration such that the gluten aggregates and forms a dense, textured structure. The plant-based meat product may be generated by extruding the plant-based composition, kneading the plant-based composition, pressure cooking the plant-based composition, autoclaving the plant-based composition, molding the plant-based composition, layering the plant-based composition, shaping the plant-based composition, flattening the plant-based composition, or laminating or folding the plant-based composition, or any combination thereof. The plant-based composition (e.g., dough) may or may not be shaped prior to molding. In an example, a specific shaping, laminating, and folding method may be used. FIG. 10 shows an example folding and shaping method for generating a plant-based food composition. Gluten in the composition described herein may function as a linker. In some cases, the plant-based composition does not comprise a linker (e.g., gluten, guar gum, xanthan gum, and methylcellulose).

The plant-based composition or the plant-based food product may comprise oil. The oil may be a plant-based oil (e.g., an oil derived from a plant source). The plant-based composition may include a single type of oil or multiple types of oil. The oil may be present in the composition from about 0.001% to about 30% of total mass. The oil content may provide comprise the major portion of the fat content of the plant-based composition. The oil can be selected from the oil of one or more of canola oil, sunflower oil, safflower oil, olive oil, avocado oil, coconut oil, orange oil, mango oil, flaxseed oil, soybean oil, or any combination thereof. The oil may be a liquid or a solid. Liquid oil may produce a plant-based composition with a more homogeneous composition. The plant-based composition (e.g., dough) or plant-based meat product may comprise greater than or equal to about 0.001%, 0.01% 0.1%, 0.5%, 1%, 5%, 10%, 20%, 30%, or more of an oil by wet weight. The plant-based composition (e.g., dough) or plant-based meat product may comprise less than or equal to about 30%, 20%, 10%, 5%, 1%, 0.5%, 0.1%, 0.01%, 0.001%, or less of an oil by wet weight. The plant-based composition (e.g., dough) or plant-based meat product may comprise from about 0.001% to 0.01%, 0.001% to 0.1%, 0.001% to 0.5%, 0.001% to 1%, 0.001% to 5%, 0.001% to 10%, 0.001% to 20%, 0.001% to 30%, 0.01% to 0.1%, 0.01% to 0.5%, 0.01% to 1%, 0.01% to 5%, 0.01% to 10%, 0.01% to 20%, 0.01% to 30%, 0.1% to 0.5%, 0.1% to 1%, 0.1% to 5%, 0.1% to 10%, 0.1% to 20%, 0.1% to 30%, 1% to 5%, 1% to 10%, 1% to 20%, 1% to 30%, 5% to 10%, 5% to 20%, 5% to 30%, 10% to 20%, 10% to 30%, or 20% to 30% of an oil by wet weight. In an example, the plant-based composition (e.g., dough) comprises from about 0.001% to about 15% oil by wet weight.

The plant-based composition (e.g., dough) may have a water content of less than or equal to about 60%, 50%, 40%, 30%, 20%, 15%, 10%, or less by wet weight. The plant-based composition (e.g., dough) may have a water content of from about 10% to 15%, 10% to 20%, 10% to 30%, 10% to 40%, 10% to 50%, 10% to 60%, 15% to 20%, 15% to 30%, 15% to 40%, 15% to 50%, 15% to 60%, 20% to 30%, 20% to 40%, 20% to 50%, 20% to 60%, 30% to 40%, 30% to 50%, 30% to 60%, 40% to 50%, 40% to 60%, or 50% to 60% water by wet weight. In an example, the plant-based composition or plant-based food product comprises less than or equal to about 60% water by wet weight. In another example, the plant-based food product comprises greater than or equal to about 50% by wet weight.

The plant-based composition may be used to generate a plant-based product. The plant-based product may be a plant-based meat product. The plant-based composition may be extruded, shaped, molded, kneaded, cooked, steam treated, pressurized, ground, or otherwise processed to generate the plant-based product (e.g., plant-based meat product).

The plant-based composition (e.g., dough) or plant-based meat product may comprise greater than or equal to about 5%, 10%, 15%, 20%, 30%, 40%, 50%, or more protein derived from one or more legumes or pulses by wet weight. The plant-based composition (e.g., dough) or plant-based meat product may comprise less than or equal to about 50%, 40%, 30%, 20%, 15%, 10%, 8%, 6%, 5%, or less protein derived from one or more legumes or pulses by wet weight. The plant-based composition (e.g., dough) or plant-based meat product may comprise from about 5% to 10%, 5% to 15%, 5% to 20%, 5% to 30%, 5% to 40%, 5% to 50%, 10% to 15%, 10% to 20%, 10% to 30%, 10% to 40%, 10% to 50%, 15% to 20%, 15% to 30%, 15% to 40%, 15% to 50%, 20% to 30%, 20% to 40%, 20% to 50%, 30% to 40%, 30% to 50%, or 40% to 50% protein derived from one or more legumes or pulses by wet weight. In an example, the plant-based composition (e.g., dough) or plant-based meat product comprises greater than or equal to about 15% protein derived from one or more legumes or pulses by wet weight. In another example, the plant-based composition (e.g., dough) or plant-based meat product comprises greater than or equal to about 20% protein derived from one or more legumes or pulses by wet weight.

The plant-based composition (e.g., dough) or plant-based meat product may comprise greater than or equal to about 0.1%, 0.5%, 1%, 5%, 10%, 15%, or more fat derived from one or more legumes or pulses by wet weight. The plant-based composition (e.g., dough) or plant-based meat product may comprise less than or equal to about 15%, 10%, 5%, 1%, 0.5%, 0.1%, or less fat derived from one or more legumes or pulses by wet weight. The plant-based composition (e.g., dough) or plant-based meat product may comprise from about 0.1% to 0.5%, 0.1% to 1%, 0.1% to 5%, 0.1% to 10%, 0.1% to 15%, 0.5% to 1%, 0.5% to 5%, 0.5% to 10%, 0.5% to 15%, 1% to 5%, 1% to 10%, 1% to 15%, 5% to 10%, 5% to 15%, or 10% to 15% fat derived from one or more legumes or pulses by wet weight. In an example, the plant-based composition (e.g., dough) or plant-based meat product comprises greater than or equal to about 5% fat derived from one or more legumes or pulses by wet weight. In another example, the plant-based composition (e.g., dough) or plant-based meat product comprises less than or equal to about 10% fat derived from one or more legumes or pulses by wet weight.

The plant-based composition (e.g., dough) or plant-based meat product may comprise greater than or equal to about 0.1%, 0.5%, 1%, 5%, 10%, 15%, or more carbohydrates derived from one or more legumes or pulses by wet weight. The plant-based composition (e.g., dough) or plant-based meat product may comprise less than or equal to about 15%, 10%, 5%, 1%, 0.5%, 0.1%, or less carbohydrates derived from one or more legumes or pulses by wet weight. The plant-based composition (e.g., dough) or plant-based meat product may comprise from about 0.1% to 0.5%, 0.1% to 1%, 0.1% to 5%, 0.1% to 10%, 0.1% to 15%, 0.5% to 1%, 0.5% to 5%, 0.5% to 10%, 0.5% to 15%, 1% to 5%, 1% to 10%, 1% to 15%, 5% to 10%, 5% to 15%, or 10% to 15% carbohydrates derived from one or more legumes or pulses by wet weight. In an example, the plant-based composition (e.g., dough) or plant-based meat product comprises greater than or equal to about 5% carbohydrates derived from one or more legumes or pulses by wet weight. In another example, the plant-based composition (e.g., dough) or plant-based meat product comprises less than or equal to about 10% carbohydrates derived from one or more legumes or pulses by wet weight.

The plant-based product (e.g., plant-based meat product) may retain greater than or equal to about 50%, 60%, 70%, 80%, 90%, or more of the initial plant matter. The plant-based product (e.g., plant-based meat product) may retain from about 50% to 60%, 50% to 70%, 50% to 80%, 50% to 90%, 50% to 100%, 60% to 70%, 60% to 80%, 60% to 90%, 60% to 100%, 70% to 80%, 70% to 90%, 70% to 100%, 80% to 90%, 80% to 100%, or 90% to 100% of the initial plant matter.

The plant-based meat product can have a structure and appearance analogous to a processed animal-based meat product, such as, for example, a nugget or a sausage, or mimic the structure and appearance of a cut of animal meat, such as, for example, a strip, a cutlet, a breast, a steak, a wing, a drumstick, a filet, a roast, or a whole chicken, turkey, or duck. The plant-based meat can mimic a whole cut of meat including, for example, breast, thighs, drumsticks, or wings. The plant-based meat can mimic, for example, beef, chicken, deer, rabbit, elk, turkey, pork, Cornish game hen, fish, shrimp, shellfish, mussels, oysters, salmon, tuna, ham, cured meat products, duck, goose, bacon, lamb, mutton, pheasant, pigeon, goat, bison, veal, boar, quail, frog, liver, heart, crab, and lobster.

The plant based meat product may contain wheat protein. The wheat protein may be derived from, for example, wheat grains, wheat flour, or wheat gluten. The product may contain a plant material with foaming properties. The foaming properties of plant precursors, such as, for example mung beans or lentils, may induce porosity in the plant based meat composition. The plant-based meat product may contain fibers, layers, or a combination thereof created by the interactions of the plant fractions with wheat gluten under various physiological conditions (e.g., heat and pressure).

The plant-based meat products described herein can be produced from at least one, two, three, four, five, six, seven, eight, nine, ten, or more of minimally processed components. The components may be selected by their functionalities (e.g., quality of protein, concentration of protein, type of protein, quality of starch, concentration of starch, quality of oil, concentration). The plant-based meat product may have a cutting force of greater than or equal to about 0.1 kilograms (kg), 0.2 kg, 0.3 kg, 0.4 kg, 0.5 kg, 0.6 kg, 0.8 kg, 1.0 kg, 1.2 kg, 1.5 kg, 2.0 kg, 2.5 kg, 3.0 kg, or more. The plant-based meat product may have a cutting force less than or equal to about 3.0 kg, 2.5 kg, 2.0 kg, 1.5 kg, 1.2 kg, 1.0 kg, 0.8 kg, 0.6 kg, 0.5 kg, 0.4 kg, 0.3 kg, 0.2 kg, 0.1 kg, or less. The plant-based meat product may have a cutting force from about 0.1 kg to 0.2 kg, 0.1 kg to 0.3 kg, 0.1 kg to 0.4 kg, 0.1 kg to 0.5 kg, 0.1 kg to 0.6 kg, 0.1 kg to 0.8 kg, 0.1 kg to 1.0 kg, 0.1 kg to 1.2 kg, 0.1 kg to 1.5 kg, 0.1 kg to 2.0 kg, 0.1 kg to 2.5 kg, 0.1 kg to 3.0 kg, 0.2 kg to 0.3 kg, 0.2 kg to 0.4 kg, 0.2 kg to 0.5 kg, 0.2 kg to 0.6 kg, 0.2 kg to 0.8 kg, 0.2 kg to 1.0 kg, 0.2 kg to 1.2 kg, 0.2 kg to 1.5 kg, 0.2 kg to 2.0 kg, 0.2 kg to 2.5 kg, 0.2 kg to 3.0 kg, 0.3 kg to 0.4 kg, 0.3 kg to 0.5 kg, 0.3 kg to 0.6 kg, 0.3 kg to 0.8 kg, 0.3 kg to 1.0 kg, 0.3 kg to 1.2 kg, 0.3 kg to 1.5 kg, 0.3 kg to 2.0 kg, 0.3 kg to 2.5 kg, 0.3 kg to 3.0 kg, 0.4 kg to 0.5 kg, 0.4 kg to 0.6 kg, 0.4 kg to 0.8 kg, 0.4 kg to 1.0 kg, 0.4 kg to 1.2 kg, 0.4 kg to 1.5 kg, 0.4 kg to 2.0 kg, 0.4 kg to 2.5 kg, 0.4 kg to 3.0 kg, 0.5 kg to 0.6 kg, 0.5 kg to 0.8 kg, 0.5 kg to 1.0 kg, 0.5 kg to 1.2 kg, 0.5 kg to 1.5 kg, 0.5 kg to 2.0 kg, 0.5 kg to 2.5 kg, 0.5 kg to 3.0 kg, 0.6 kg to 0.8 kg, 0.6 kg to 1.0 kg, 0.6 kg to 1.2 kg, 0.6 kg to 1.5 kg, 0.6 kg to 2.0 kg, 0.6 kg to 2.5 kg, 0.6 kg to 3.0 kg, 0.8 kg to 1.0 kg, 0.8 kg to 1.2 kg, 0.8 kg to 1.5 kg, 0.8 kg to 2.0 kg, 0.8 kg to 2.5 kg, 0.8 kg to 3.0 kg, 1.0 kg to 1.2 kg, 1.0 kg to 1.5 kg, 1.0 kg to 2.0 kg, 1.0 kg to 2.5 kg, 1.0 kg to 3.0 kg, 1.2 kg to 1.5 kg, 1.2 kg to 2.0 kg, 1.2 kg to 2.5 kg, 1.2 kg to 3.0 kg, 1.5 kg to 2.0 kg, 1.5 kg to 2.5 kg, 1.5 kg to 3.0 kg, 2 kg to 2.5 kg, 2.0 kg to 3.0 kg, or 2.5 kg to 3.0 kg.

### Plant-Based Coating Compositions

The disclosure provides plant-based compositions that can be used to coat both plant-based alternatives to animal-based meat products and animal-based meat products themselves. Such coatings can also be used for other foods beyond meats, including fruits, vegetable and dairy products. In some cases, the coating mimics the outer material of one or more surfaces, both internally and externally, of an animal-based meat product, such as the skin, intramuscular tissue, cartilaginous tissue, or connective tissue of the animal-based muscle. A plant-based coating composition described herein, including one that mimics a coating and or layer(s) of a meat or meat product (e.g., a “skin” or a “connective tissue”), may comprise at least one species of plant, such as, for example legume (e.g., bean or pulse) and cereals (e.g., grains). The legume may be, for example, a pea (e.g., yellow pea, yellow split pea, green pea, or sweet pea), a black bean, a mung bean, a red bean, a kidney bean, a cannellini bean, a garbanzo bean, or a lentil. The cereals may be, for example, rice, corn, wheat, oat, or barley. Legume curd may be used as a base for plant-based coating products. Cereal curd may be used as a base for plant-based coating products. In an example, the plant-based coating composition may comprise soy, Yuba, rice paper or any combination thereof. The plant-based coating composition may comprise a single layer of Yuba or rice paper or multiple layers of Yuba or rice paper. In another example, the plant-based coating may comprise one or more of a protein-based edible film or coating, a starch-based edible film or coating, a non-starch polysaccharide edible film or coating, a lipid-based edible film or coating, an emulsion and bi-layer edible film or coating, an edible gel, or any combination thereof. A protein-based edible film or coating may include one or more plant proteins, for example, soybean, mung bean, wheat, corn, cottonseed, other plant proteins, or any combination thereof. A starch-based edible film or coating may include one or more plant starches derived from corn, wheat, rice, potato, sweet potato, cassava, pea, chickpea, other plant derived starches, or any combination thereof. A non-starch polysaccharide film or coating may include cellulosic derivatives (e.g., chitosan, seaweed extracts, pectin, microbial polysaccharides, or any combination thereof), exudate gums, seed gums, or any combination thereof. A lipid-based edible film or coating may include vegetable waxes (e.g., carnauba wax, candelilla wax, ouricury wax, sugar cane wax, jojoba oil, bayberry wax, Japan wax, rice bran oil, or any combination thereof), vegetable oils, fatty acids, or any combination thereof. An emulsion film may include protein- and polysaccharide-based emulsions. An edible gel may include agar, aloe vera gel, carrageenan, methylcellulose, sodium alginate, pectin, or any combination thereof.

The plant-based coating or film may be disposed on an external surface of the plant-based composition (e.g., on an external surface of a 3D food product). Alternatively, or in addition to, the plant-based coating or film may be disposed internal to the 3D structure of the plant-based composition. The plant-based composition may include a plurality of discreet units comprising a 3D structure. The discreet units may be a molded or otherwise shaped 3D structure comprising, or not comprising, fibers. For example, a discreet unit may be a fiber bundle. At least a portion of the discreet unit may be coated with the plant-based coating. In an example, the discreet unit is covered or encapsulated by the plant-based coating to generate a coated discreet unit. The discreet unit may be configured to or may replicate muscle tissue. A plurality of discreet units may be molded, shaped, or otherwise fit together to form a 3D macrostructure. The 3D macrostructure may include an additional plant-based coating disposed on an outer surface, for example, coating or encapsulating, the 3D macrostructure. The internal plant-based coating may be configured to or may replicate intramuscular tissue, connective tissue, or both. The external plant-based coating may be configured to or may replicate or mimic skin.

The plant-based coating composition may comprise greater than or equal to about 1, 2, 3, 4, 5, 6, 8, or more layers of the coating. The plant-based coating composition may have any thickness. The thickness of the coating may be greater than or equal to about 0.01 millimeters (mm), 0.05 mm, 0.1 mm, 0.5 mm, 1 mm, 2 mm, 3 mm, 4 mm, 5 mm, 6 mm, 8 mm, 10 mm, 15 mm, or thicker. The thickness of the coating may be from about 0.01 mm to 0.05 mm, 0.01 mm to 0.1 mm, mm, 0.01 mm to 0.5 mm, 0.01 mm to 1 mm, 0.01 mm to 2 mm, 0.01 mm to 3 mm, 0.01 mm to 4 mm, 0.01 mm to 5 mm, 0.01 mm to 6 mm, 0.01 mm to 8 mm, 0.01 mm to 10 mm, 0.01 mm to 15 mm, 0.05 mm to 0.1 mm, 0.05 mm to 0.5 mm, 0.05 mm to 1 mm, 0.05 mm to 2 mm, 0.05 mm to 3 mm, 0.05 mm to 4 mm, 0.05 mm to 5 mm, 0.05 mm to 6 mm, 0.05 mm to 8 mm, 0.05 mm to 10 mm, 0.05 mm to 15 mm, 0.1 mm to 0.5 mm, 0.1 mm to 1 mm, 0.1 mm to 2 mm, 0.1 mm to 3 mm, 0.1 mm to 4 mm, 0.1 mm to 5 mm, 0.1 mm to 6 mm, 0.1 mm to 8 mm, 0.1 mm to 10 mm, 0.1 mm to 15 mm, 0.5 mm to 1 mm, 0.5 mm to 2 mm, 0.5 mm to 3 mm, 0.5 mm to 4 mm, 0.5 mm to 5 mm, 0.5 mm to 6 mm, 0.5 mm to 8 mm, 0.5 mm to 10 mm, 0.5 mm to 15 mm, 1 mm to 2 mm, 1 mm to 3 mm, 1 mm to 4 mm, 1 mm to 5 mm, 1 mm to 6 mm, 1 mm to 8 mm, 1 mm to 10 mm, 1 mm to 15 mm, 2 mm to 3 mm, 2 mm to 4 mm, 2 mm to 5 mm, 2 mm to 6 mm, 2 mm to 8 mm, 2 mm to 10 mm, 2 mm to 15 mm, 3 mm to 4 mm, 3 mm to 5 mm, 3 mm to 6 mm, 3 mm to 8 mm, 3 mm to 10 mm, 3 mm to 15 mm, 4 mm to 5 mm, 4 mm to 6 mm, 4 mm to 8 mm, 4 mm to 10 mm, 4 mm to 15 mm, 5 mm to 6 mm, 5 mm to 8 mm, 5 mm to 10 mm, 5 mm to 15 mm, 6 mm to 8 mm, 6 mm to 10 mm, 6 mm to 15 mm, 8 mm to 10 mm, 8 mm to 15 mm, or 10 mm to 15 mm. For example, the plant-based coating composition may have a thickness of from about 0.01 millimeters (mm) to about 10 mm. In some cases, the plant-based coating composition may comprise soy.

The plant-based coating compositions may have, for example, structures, textures, appearances, sensory properties, functional properties, or any combination thereof that resemble those of animal skin, such as, for example, the skin of poultry (e.g., chicken, duck, pigeon, goose or turkey), beef, or pork. The plant-based coating composition may be used to coat plant-based meat products, such as, for example, plant-based beef, chicken, turkey, or pork or to coat animal-based meat products. Coatings can also be used to coat natural meat products. Applying the plant-based coating to a plant-based meat product may add moisture, flavor, and nutrition to a plant-based meat product. The plant-based coating composition may provide the complexity of mouth feel, texture, and flavor similar to animal-based meat or meat products. The plant-based coating composition described herein may be devoid of saturated fats (e.g., found in animal skin), while providing a mouthfeel similar to animal skin.

The plant-based coating may comprise a variety of mechanical and compositional properties. The plant-based coating may have a tensile strength. The tensile strength of the plant-based coating may be greater than or equal to about 0 megapascal (MPa), 1 MPa, 2 MPa, 3 MPa, 4 MPa, 5 MPa, 6 MPa, 8 MPa, 10 MPa, 12 MPa, 15 MPa, 20 MPa, 25 MPa, 30 MPa, 40 MPa, 50 MPa, or more as measured at a relative humidity of 50% and temperature of 25° C. The tensile strength of the plant-based coating may be less than or equal to about 50 MPa, 40 MPa, 30 MPa, 25 MPa, 20 MPa, 15 MPa, 12 MPa, 10 MPa, 8 MPa, 6 MPa, 5 MPa, 4 MPa, 3 MPa, 2 MPa, or 1 MPa, as measured at a relative humidity of 50% and temperature of 25° C. the tensile strength of the plant-based coating may be from about 0 to 1 MPa, 0 to 2 MPa, 0 to 3 MPa, 0 to 4 MPa, 0 to 5 MPa, 0 to 6 MPa, 0 to 8 MPa, 0 to 10 MPa, 0 to 12 MPa, 0 to 15 MPa, 0 to 20 MPa, 0 to 25 MPa, 0 to 30 MPa, 0 to 40 MPa, 0 to 50 MPa, 1 to 2 MPa, 1 to 3 MPa, 1 to 4 MPa, 1 to 5 MPa, 1 to 6 MPa, 1 to 8 MPa, 1 to 10 MPa, 1 to 12 MPa, 1 to 15 MPa, 1 to 20 MPa, 1 to 25 MPa, 1 to 30 MPa, 1 to 40 MPa, 1 to 50 MPa, 2 to 3 MPa, 2 to 4 MPa, 2 to 5 MPa, 2 to 6 MPa, 2 to 8 MPa, 2 to 10 MPa, 2 to 12 MPa, 2 to 15 MPa, 2 to 20 MPa, 2 to 25 MPa, 2 to 30 MPa, 2 to 40 MPa, 2 to 50 MPa, 3 to 4 MPa, 3 to 5 MPa, 3 to 6 MPa, 3 to 8 MPa, 3 to 10 MPa, 3 to 12 MPa, 3 to 15 MPa, 3 to 20 MPa, 3 to 25 MPa, 3 to 30 MPa, 3 to 40 MPa, 3 to 50 MPa, 4 to 5 MPa, 4 to 6 MPa, 4 to 8 MPa, 4 to 10 MPa, 4 to 12 MPa, 4 to 15 MPa, 4 to 20 MPa, 4 to 25 MPa, 4 to 30 MPa, 4 to 40 MPa, 4 to 50 MPa, 5 to 6 MPa, 5 to 8 MPa, 5 to 10 MPa, 5 to 12 MPa, 5 to 15 MPa, 5 to 20 MPa, 5 to 25 MPa, 5 to 30 MPa, 5 to 40 MPa, 5 to 50 MPa, 6 to 8 MPa, 6 to 10 MPa, 6 to 12 MPa, 6 to 15 MPa, 6 to 20 MPa, 6 to 25 MPa, 6 to 30 MPa, 6 to 40 MPa, 6 to 50 MPa, 8 to 10 MPa, 8 to 12 MPa, 8 to 15 MPa, 8 to 20 MPa, 8 to 25 MPa, 8 to 30 MPa, 8 to 40 MPa, 8 to 50 MPa, 10 to 12 MPa, 10 to 15 MPa, 10 to 20 MPa, 10 to 25 MPa, 10 to 30 MPa, 10 to 40 MPa, 10 to 50 MPa, 12 to 15 MPa, 12 to 20 MPa, 12 to 25 MPa, 12 to 30 MPa, 12 to 40 MPa, 12 to 50 MPa, 15 to 20 MPa, 15 to 25 MPa, 15 to 30 MPa, 15 to 40 MPa, 15 to 50 MPa, 20 to 25 MPa, 20 to 30 MPa, 20 to 40 MPa, 20 to 50 MPa, 25 to 30 MPa, 25 to 40 MPa, 25 to 50 MPa, 30 to 40 MPa, 30 to 50 MPa, or 40 to 50 MPa. In an example, the plant-based coating has a tensile strength of from about 0 to 25 MPa.

The plant-based coating may comprise a variety of compositions, including, but not limited to, lipids, protein, sugar, or any combination thereof. The plant-based coating may have a lipid to protein mass ratio of greater than or equal to about 0, 0.1, 0.2, 0.3, 0.4, 0.5, 0.6, 0.7, 0.8, 0.9 or more. The plant-based coating may have a lipid to protein mass ratio of less than or equal to 1, 0.9, 0.8, 0.7, 0.6, 0.5, 0.4, 0.3, 0.2, 0.1, or less. The plant-based coating may have a lipid to protein mass ratio from about 0 to 0.1, 0 to 0.2, 0 to 0.3, 0 to 0.4, 0 to 0.5, 0 to 0.6, 0 to 0.7, 0 to 0.8, 0 to 0.9, 0 to 1, 0.1 to 0.2, 0.1 to 0.3, 0.1 to 0.4, 0.1 to 0.5, 0.1 to 0.6, 0.1 to 0.7, 0.1 to 0.8, 0.1 to 1, 0.1 to 1, 0.2 to 0.3, 0.2 to 0.4, 0.2 to 0.5, 0.2 to 0.6, 0.2 to 0.7, 0.2 to 0.8, 0.2 to 0.9, 0.2 to 1, 0.3 to 0.4, 0.3 to 0.5, 0.3 to 0.6, 0.3 to 0.7, 0.3 to 0.8, 0.3 to 0.9, 0.3 to 1, 0.4 to 0.5, 0.4 to 0.6, 0.4 to 0.7, 0.4 to 0.8, 0.4 to 0.9, 0.4 to 1, 0.5 to 0.6, 0.5 to 0.7, 0.5 to 0.8, 0.5 to 0.9, 0.5 to 1, 0.6 to 0.7, 0.6 to 0.8, 0.6 to 0.9, 0.6 to 1, 0.7 to 0.8, 0.7 to 0.9, 0.7 to 1, 0.8 to 0.9, 0.8 to 1, or 0.9 to 1. In an example, the plant-based coating has a lipid to protein mass ratio from about 0.1 to 0.6. In another example, the plant-based coating has a lipid to protein mass ratio from about 0 to 1. The plant-based coating may have a sugar to protein mass ratio of greater than or equal to about 0, 0.1, 0.2, 0.3, 0.4, 0.5, 0.6, 0.7, 0.8, 0.9, or more. The plant-based coating may have a sugar to protein mass ratio of less than or equal to 1, 0.9, 0.8, 0.7, 0.6, 0.5, 0.4, 0.3, 0.2, 0.1, or less. The plant-based coating may have a sugar to protein mass ratio from about 0 to 0.1, 0 to 0.2, 0 to 0.3, 0 to 0.4, 0 to 0.5, 0 to 0.6, 0 to 0.7, 0 to 0.8, 0 to 0.9, 0 to 1, 0.1 to 0.2, 0.1 to 0.3, 0.1 to 0.4, 0.1 to 0.5, 0.1 to 0.6, 0.1 to 0.7, 0.1 to 0.8, 0.1 to 0.9, 0.1 to 1, 0.2 to 0.3, 0.2 to 0.4, 0.2 to 0.5, 0.2 to 0.6, 0.2 to 0.7, 0.2 to 0.8, 0.2 to 0.9, 0.2 to 1, 0.3 to 0.4, 0.3 to 0.5, 0.3 to 0.6, 0.3 to 0.7, 0.3 to 0.8, 0.3 to 0.9, 0.3 to 1, 0.4 to 0.5, 0.4 to 0.6, 0.4 to 0.7, 0.4 to 0.8, 0.4 to 0.8, 0.4 to 1, 0.5 to 0.6, 0.5 to 0.7, 0.5 to 0.8, 0.5 to 0.9, 0.5 to 1, 0.6 to 0.7, 0.6 to 0.8, 0.6 to 0.9, 0.6 to 1, 0.7 to 0.8, 0.7 to 0.9, 0.7 to 1, 0.8 to 0.9, 0.8 to 0.9, or 0.9 to 1. In an example, the plant-based coating has a sugar to protein mass ratio from about 0.1 to 0.6. In another example, the plant-based coating has a sugar to protein mass ratio from about 0 to 1.

The plant-based coating may be structurally similar to animal skin. The plant-based coating may have a low fat content of roughly 1-30 grams (g) per 100 g. The plant-based skin may be texturally similar to animal skin. The plant-based coating product may be manufactured and prepared alone or applied to plant-based meat of any composition by methods including, for example, dipping, drizzling, soaking, shaking, wrapping, or molding. The plant-based coating may be applied wet or dry. The thickness of the plant-based coating composition can be altered by layering multiple layers of the coating onto a plant-based meat product. The texture, mechanical properties, and nutritional content of the plant plant-based coating composition can be controlled or altered by heating condition, heating duration, pH, and etc. Color can be modified by choosing the legume with various colors. Artificial coloration may or may not be added. In an example, artificial coloration may not be added. Artificial coloration may include colors added to the plant-based food product by food safe dyes and synthetic coloring agents. Color may be varied by the addition of plant-based material such as, for example, beet juice, elderberry juice, turmeric, paprika, red onion, or other plant-based material that may alter the color of the product using methods described elsewhere herein. The plant-based coating may have a lightness (L*) that at least partially describes the color space of the plant-based coating. For example, a lightness of zero may be a black plant-based coating and a lightness of 100 may be a diffuse white plant-based coating. The lightness of the plant-based coating may be greater than or equal to about 10, 20, 30, 40, 50, 60, 70, 80, or more. The lightness of the plant-based coating may be less than or equal to about 80, 70, 60, 50, 40, 30, 20, 10, or less. The lightness of the plant-based coating may be from about 10 to 20, 10 to 30, 10 to 40, 10 to 50, 10 to 60, 10 to 70, 10 to 80, 20 to 30, 20 to 40, 20 to 50, 20 to 60, 20 to 70, 20 to 80, 30 to 40, 30 to 50, 30 to 60, 30 to 70, 30 to 80, 40 to 50, 40 to 60, 40 to 70, 40 to 80, 50 to 60, 50 to 70, 50 to 80, 60 to 70, 60 to 80, or 70 to 80. In an example, the lightness of the plant-based coating is from about 30 to 70.

A plant-based meat product, including the coating and the meat, or a product made entirely of the plant based coating, such as, for example, vegan crackling or chicharron, can be further processed by methods including, for example, marinating, seasoning, dehydrating, hydrating, flavoring, tenderizing, grilling, frying, or combinations thereof performed together or in sequence. The plant-based meat products may have a crunchiness and hardness similar to animal meat after further cooking, such as, for example, frying or baking. The plant-based meat product may create an eating experience and mouthfeel similar to that of cooked animal meat. The product may create an eating experience and mouthfeel similar to that of cooked animal whole cut meat. The mouthfeel of the plant-based meat product may be determined by physical characteristics of the plant-based meat product such as, for example, structure, dryness, density, adhesiveness, bounce, chewiness, coarseness, cohesiveness, fracturability, graininess, gumminess, hardness, heaviness, moisture adsorption, moisture release, mouthcoating, roughness, slipperiness, smoothness, uniformity, and viscosity.

### Methods of Producing Plant-Based Compositions

In an aspect, the present disclosure provides methods for producing a food composition. The food composition may be a plant-based composition. The food composition may be produced by providing a first mixture and a second mixture, shaping the first mixture into a three-dimensional structure, and coating at least a portion of the three-dimensional structure with one or more layers of the second mixture to generate a coated three-dimensional structure. The first mixture may be derived from a plant-based material. The first mixture, the second mixture, or both may not include an animal-derived component. The three-dimensional structure may replicate or mimic animal tissue. The one or more layers of the second material may replicate or mimic a feature of animal tissue. The feature of the animal tissue may include is intramuscular tissue, connective tissue, cartilaginous tissue, or any combination thereof. The one or more layers of the second material may adhere to the three-dimensional structure.

In another aspect, the present disclosure provides methods for producing a food composition. The food composition may be a plant-based composition. The food composition may be produced by providing a mixture and processing the mixture to generate a three-dimensional structure comprising substantially aligned fibers. The mixture may include one or more plant-based material. The mixture may not include an animal-derived component. Processing the mixture may include stretching the mixture, folding the mixture, layering the mixture, or any combination thereof.

Materials, such as pulses, used to generate plant-based compositions can be processed to generate powdered materials (e.g., powdered beans, including, for example, whole powdered beans, protein-enriched bean powder, starch enriched bean powder), pureed materials (e.g., pureed beans), or milk materials (e.g., bean milk, including whole bean milk, protein-enriched bean milk, starch enriched bean milk). Any number of powdered, pureed or milk materials can be generated. Each can be generated from a single material (e.g., a single pulse type) or multiple materials (e.g., multiple types of pulses). Moreover, powdered, pureed, or milk materials can be subsequently processed individually or one or more can be combined into a mixture and the mixture further processed. Such materials or mixtures of these materials may be further processed with heat or heating may be omitted. Moreover, such materials or mixtures may also be pH-adjusted or pH-adjusting may be omitted.

The operations can produce a semi-fluid material. Such material may then be mixed with a linker, such as gluten, to increase the viscosity and elasticity of the mixture. Subsequently, directional alignment (e.g., stretching, rolling, stacking, spinning, etc.) of the plant-based material may be performed to obtain textural, consistency, or other physical parameters. The resulting product may also be subject to shaping, such as, for example via extrusion through a die or through three-dimensional molding. Molds may be made from silicone rubber, plastic, stainless steel, or aluminum. Molds may be flexible. Molds may be ridged. In some cases, extrusion is not used for shaping or in any part of making a plant-based animal product, including plant-based meats and skins described elsewhere herein. In some cases, a process for making a plant-based animal product (e.g., a plant-based meat, plant-based skin) does not comprise extrusion.

Processes for producing plant-based meat products are described herein. The process may include protein denaturation, protein alignment into protein fibers, and creating sub-structures of fibrous bundles in a way that is organoleptically analogous to animal muscle bundles in meat, as well as the unification of these bundles into larger, more complex structures that resemble whole, structured cuts of meat (for instance, a whole chicken breast or wing). In some cases, a process for producing a plant-based product, including a plant-based meat or skin, comprises heat-treating, pressure cooking (e.g., including steam pressure cooking), steam cooking, or autoclaving.

Methods for making plant-based meat products may comprise stretching the plant-based composition described herein. The stretching may produce a composition with directional fibers. In some cases, the stretched product can be steam cooked from about 50° C. to about 150° C. under pressure from about 5 to 20 psi for about 10 minutes to about 60 minutes. The plant-based composition may be cooked at temperatures of greater than or equal to about 50° C., 75° C., 100° C., 125° C., 150° C., or more. The plant-based composition may be cooked at temperatures from about 50° C. to 75° C., 50° ° C. to 100° C., 50° ° C. to 125° C., 50° ° C. to 150° C., 75° C. to 100° C., 75° ° C. to 125° C., 75° C. to 150° C., 100° ° C. to 125° C., 100° ° C. to 150° ° C., or 125° C. to 150° C. In an example, the plant-based composition is cooked between about 100° C. and 150° C. The plant-based composition may be cooked at pressures of greater than or equal to about 1 psi, 5 psi, 10 psi 15 psi, 20 psi, 30 psi, or more. The plant-based composition may be cooked at pressures from about 1 psi to 5 psi, 1 psi to 10 psi, 1 psi to 15 psi, 1 psi to 20 psi, 5 psi to 10 psi, 5 psi to 15 psi, 5 psi to 20 psi, 10 psi to 15 psi, 10 psi to 20 psi, or 15 psi to 20 psi. In an example, the plant-based composition is cooked at pressures from about 10 psi to 30 psi. Longer cook times may increase the hardness of the product and fiber appearance. Fiber formation after at least 5-15 minutes of cooking may provide the plant-based composition with a texture as well as provide the plant-based composition with a similar appearance to animal meat.

The disclosure provides methods for the use of plant-based coatings in generating a plant-based composition (e.g., plant-based meat product). The plant-based coating may be as described elsewhere herein. In an example, the plant-based coating comprises a protein-enriched film or coating, a starch-enriched film or coating, a non-starch polysaccharide edible film or coating, a lipid-based edible film or coating, an emulsion and bi-layer edible film or coating, edible gel, or any combination thereof. In an example, the plant-based coating may include legume curds (e.g., pea curd). The plant-based coating composition described herein can be produced from a legume curd. In an example, the curd can be produced from at least one ingredient by soaking beans or pulses in water from about 1 hour to about 24 hours, or until they at least double in mass. Alternatively, the coating composition described herein may be produced from a different legume ingredient or a combination of legume ingredients. The soaking may be followed by grinding or milling the legume in a ratio with water ranging from 1:1 to 1:6. Higher or lower ratios can also be used to adjust mechanical and physical properties. For example, a higher ratio of water may produce a thinner, less viscous coating consistency. The resulting legume-water homogenization can then be settled in a vessel, such as, for instance, a tank, for about 1 hour to about 10 hours. Longer or shorter settling times can also be used to adjust amounts of materials in the resulting composition. For example, a longer settling period may allow more starch to accumulate in the lower fraction. Centrifugation can be used to shorten settling times.

The starch-poor fraction can then be heated from about 50° C. to about 100° C. At least a portion of the starch-poor fraction or at least a portion of the settled fractions may be altered or discarded to alter the texture of the plant-based coating composition. Alternatively, each component of each fraction may be used. After the starch-poor fraction loses about 10% to about 50% of water mass, the starch-rich fraction can be added to the heated starch-poor fraction, producing a thickened composition. Separating the legume material into two fraction and then combining each fraction step-wise may allow the thickening process to produce a more evenly mixed coating composition. Moreover. Sedimenting the starch before heating may be advantageous at least for decreasing uneven thickening and creation of clusters of starch-rich aggregates/lump formation.

The plant-based coating composition may be applied to a plant-based composition via, for example, dipping, drizzling, layering, injecting, brushing, soaking, wrapping, spraying, coating, or any combination thereof. After coating the substrate, the curd can be dried from about 0° C. to about 25° C. over a period of about 30 minutes to about 12 hours. Different temperature ranges and different times may also be used as appropriate. Moreover, altering the humidity of the drying environment, as well as adjusting the orientation of the coated substrate, may affect the dried texture, and can be used to achieve different effects to mimic different types of coatings, including animal skin.

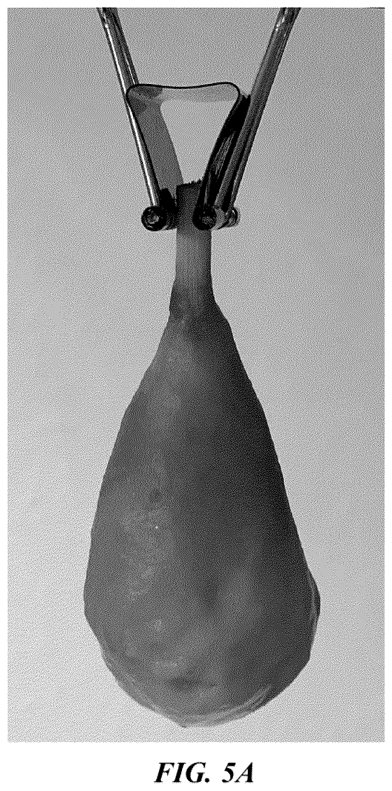

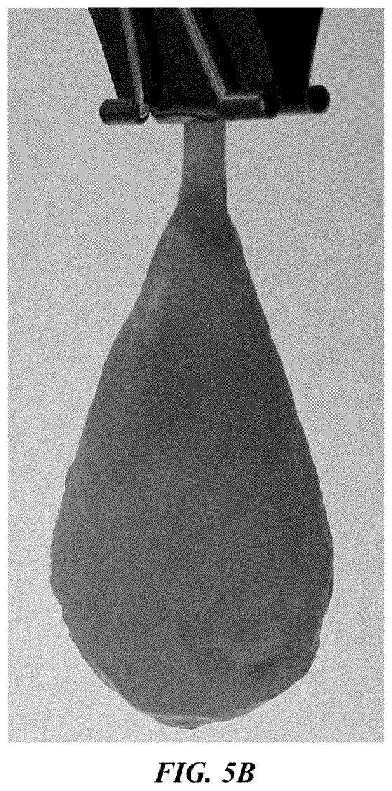

Multiple coats can be applied at, for example, 0 to 12 hour intervals to create a thicker skin texture (FIG. 5A and FIG. 5B). Other intervals can also be used. Multiple coats may provide a composition that has an organoleptic impression of a single, thicker coating. The coating, with or without additives (e.g., colorants or flavorings), may have a coloration ranging from transparent to opaque. The color of the coating may depend at least in part on the relative starch content and thickness. Dyes, flavorants, lipids, and other additives can be added to alter the color, texture, nutritional profile, and flavor of the product.

Methods may further comprise generating a coated three-dimensional structure via the methods and compositions described elsewhere herein. The three-dimensional structure may include a plant-based composition comprising substantially aligned fibers at least partially coated by or otherwise encapsulated by a plant-based coating. The substantially aligned fibers may replicate or mimic muscle fibers. The plant-based coating may replicate or mimic intramuscular tissue, connective tissue, or both. A plurality of three-dimensional structures may be assembled into a macrostructure. The plurality of three-dimensional structures or macrostructure may include at least 2, 3, 4, 5, 6, 8, 10, 12, 15, 20 or more three-dimensional structures. In an example, the plurality of three-dimensional structures or macrostructure comprises at least three three-dimensional structures. The macrostructure may include the plant-based coating disposed at least partially internally to the plurality of three-dimensional structures or macrostructure. The plurality of three-dimensional structures or macrostructure may further include an additional plant-based coating disposed on an external surface of the plurality of three-dimensional structures or macrostructure or at least partially encapsulating the plurality of three-dimensional structures or macrostructure. In an example, the internal plant-based coating is applied to individual three-dimensional structures of plant-based composition, for example, to an individual three-dimensional structure of coated fiber bundle-like structures. The coated three-dimensional structures may be assembled into the macrostructure and coated. Alternatively, or in addition to, the individual three-dimensional structures may be combined into the macrostructure and the plant-based coating may be applied to the internal structure of the macrostructure via injection of the plant-based coating into the macrostructure. Additionally, fiber, starch, or fat may be injected between the fibers or bundles to incorporate the fiber, start, or fat into the three-dimensional structure.

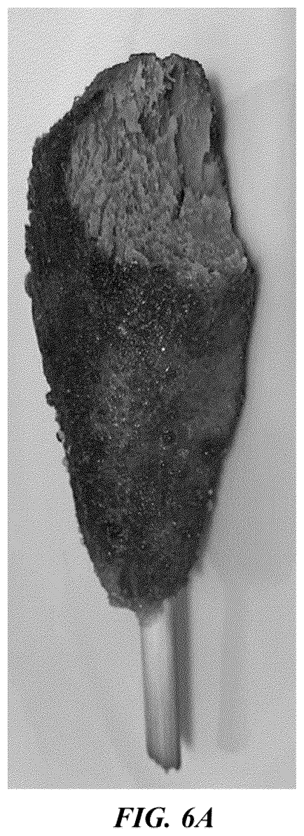

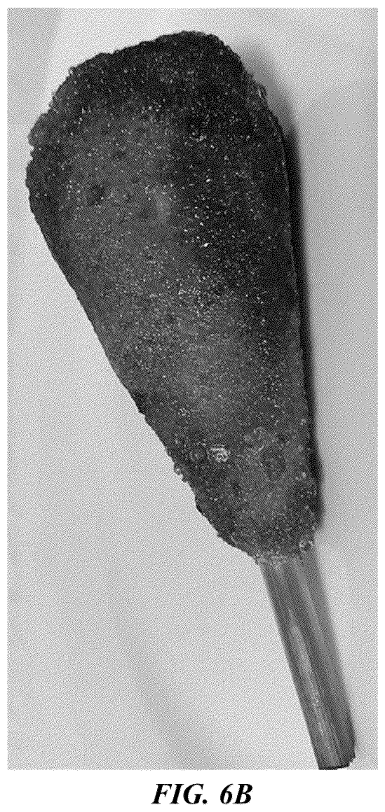

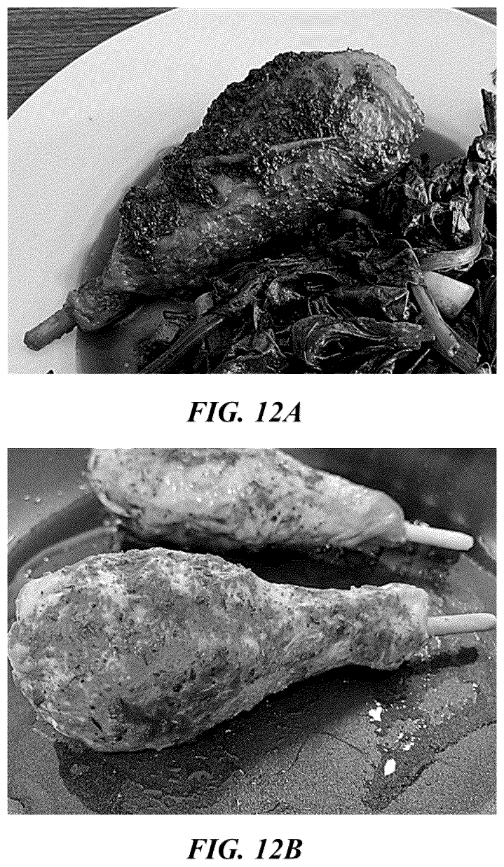

Methods may further comprise baking, frying, marinating, aerating, braising, breading, seasoning, or grilling the plant-based composition, plant-based coating, or any combination thereof to replicate or mimic taste, texture or physical or organoleptic properties of an animal tissue. FIGS. 12A and 12B show an example of marinating and pan-frying a coated plant-based meat composition. When cooked (e.g., fried, baked, sautéed, steamed, boiled, etc.), the coating may crisp in a way similar to animal skin, having the appearance of animal skin (FIG. 6A and FIG. 6B). The plant-based coating can be cooked and eaten without being applied to a plant-based meat product to produce a skin-only meat imitation, such as, for example, crackling or chicharron. The plant-based coating can be spread to the appropriate thickness and allowed to dry for a period of time dependent upon its thickness, and then cut and treated as animal skin.

### Computer Systems

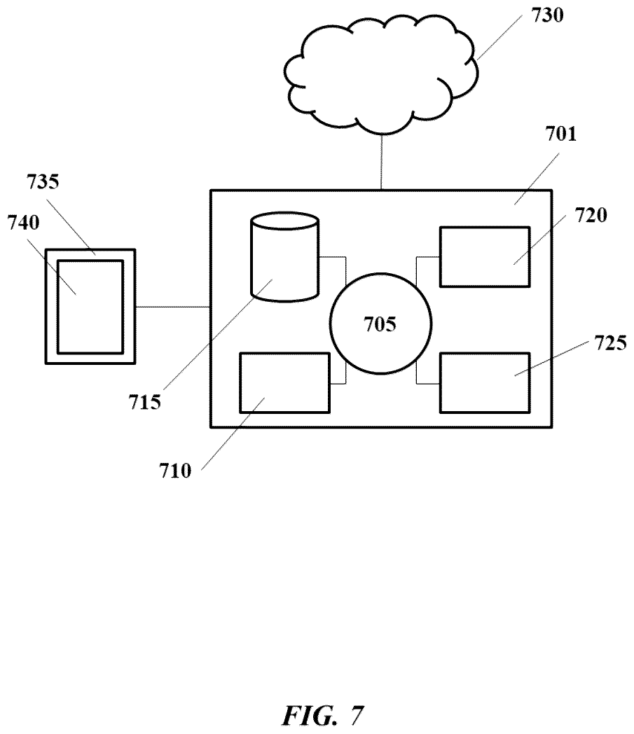

The present disclosure provides computer systems that are programmed to implement methods of the disclosure. FIG. 7 shows a computer system 701 that is programmed or otherwise configured to produce a plant-based composition described herein. The computer system 701 can regulate various aspects of the production of the plant-based composition of the present disclosure, such as, for example, equipment functionality, process controls, quality control, data processing, or processing the plant-based composition. The computer system 701 can be an electronic device of a user or a computer system that is remotely located with respect to the electronic device. The electronic device can be a mobile electronic device.

The computer system 701 includes a central processing unit (CPU, also “processor” and “computer processor” herein) 705, which can be a single core or multi core processor, or a plurality of processors for parallel processing. The computer system 701 also includes memory or memory location 710 (e.g., random-access memory, read-only memory, flash memory), electronic storage unit 715 (e.g., hard disk), communication interface 720 (e.g., network adapter) for communicating with one or more other systems, and peripheral devices 725, such as cache, other memory, data storage or electronic display adapters. The memory 710, storage unit 715, interface 720 and peripheral devices 725 are in communication with the CPU 705 through a communication bus (solid lines), such as a motherboard. The storage unit 715 can be a data storage unit (or data repository) for storing data. The computer system 701 can be operatively coupled to a computer network (“network”) 730 with the aid of the communication interface 720. The network 730 can be the Internet, an internet or extranet, or an intranet or extranet that is in communication with the Internet. The network 730 in some cases is a telecommunication or data network. The network 730 can include one or more computer servers, which can enable distributed computing, such as cloud computing. The network 730, in some cases with the aid of the computer system 701, can implement a peer-to-peer network, which may enable devices coupled to the computer system 701 to behave as a client or a server.

The CPU 705 can execute a sequence of machine-readable instructions, which can be embodied in a program or software. The instructions may be stored in a memory location, such as the memory 710. The instructions can be directed to the CPU 705, which can subsequently program or otherwise configure the CPU 705 to implement methods of the present disclosure. Examples of operations performed by the CPU 705 can include fetch, decode, execute, and writeback.

The CPU 705 can be part of a circuit, such as an integrated circuit. One or more other components of the system 701 can be included in the circuit. In some cases, the circuit is an application specific integrated circuit (ASIC).

The storage unit 715 can store files, such as drivers, libraries and saved programs. The storage unit 715 can store user data, e.g., user preferences and user programs. The computer system 701 in some cases can include one or more additional data storage units that are external to the computer system 701, such as located on a remote server that is in communication with the computer system 701 through an intranet or the Internet.

The computer system 701 can communicate with one or more remote computer systems through the network 730. For instance, the computer system 701 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iphone, Android-enabled device, Blackberry®), or personal digital assistants. The user can access the computer system 701 via the network 730.

Methods as described herein can be implemented by way of machine (e.g., computer processor) executable code stored on an electronic storage location of the computer system 701, such as, for example, on the memory 710 or electronic storage unit 715. The machine executable or machine readable code can be provided in the form of software. During use, the code can be executed by the processor 705. In some cases, the code can be retrieved from the storage unit 715 and stored on the memory 710 for ready access by the processor 705. In some situations, the electronic storage unit 715 can be precluded, and machine-executable instructions are stored on memory 710.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 701, can be embodied in programming. Various aspects of the technology may be thought of as “products” or “articles of manufacture” typically in the form of machine (or processor) executable code or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

The computer system 701 can include or be in communication with an electronic display 735 that comprises a user interface (UI) 740 for providing, for example, quality control information, data processing, or options for manipulating the process for producing the plant-based composition described herein. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 705.

### EXAMPLES

### Example 1: Legume Puree

The plant protein source, such as, for example, legume protein, are soaked in a liquid until the plant protein source doubles in size compared to the dry weight. The soaked plant protein source is mixed with a liquid at a ratio from about 2:1 to about 1:6, and then heated. The mixture is heated from about 50° ° C. to about 200° ° C. under a pressure ranging from about 5 to about 15 psi for about 1 minute to about 1 hour. The mixture is pureed until homogenous.

### Example 2: Legume Milk

Whole legumes are soaked until they double in weight from dry mass. The beans are pureed with water at a ratio from about 2:1 to about 1:6. The resulting plant “milk” undergoes filtering and separation via processes. Filtering and separation processes may include, for example, sieving, centrifugation, or sedimentation.

The resulting solid is either untreated or treated by heating from about 50° C. to about 200° C., reducing the water mass in the solid by 1-25% and causing protein denaturation. The type of treatment can lead to differences in the interactions that the proteins have with the puree, other milks, or other additives. Denatured protein milk may be more likely to undergo fibrilization and form meat-like layers. Non-denatured protein milk may not unfold, forming shorter fibers. The resulting treated or untreated milk contains the legume protein that can interact with the other components of the composition.

Non-denatured protein milk, in the presence of glutenin proteins, which relax their structure in water, and with or without another source of denatured or non-denatured protein, may interact with fibers of glutenin and be inserted into the loose fibrous network formed by relaxed glutenin molecules, and may interfere with the tight disulfide linkages formed by gliadin proteins between different molecules of glutenin, allowing for a less strictly defined structure. The “dough” containing these proteins may be stretched, laminated, or otherwise manipulated to lend a directionality to the loosely formed fibrous network. These non-denatured proteins, when placed under heat and/or pressure for instance as in the case of pressure cooking at 120° C. and 30 psi for 20 minutes, may be denatured to permit alignment as part of the fibrous network already loosely formed before cooking by various gluten proteins. These interactions may be further influenced by the presence and relative concentrations of other plant materials, including naturally or occurring or added starch, fiber, or fat, and by their behavior at different points during processing due to alterations in temperature, pressure, etc.

### Example 3: Preparation of Plant-Based Meat

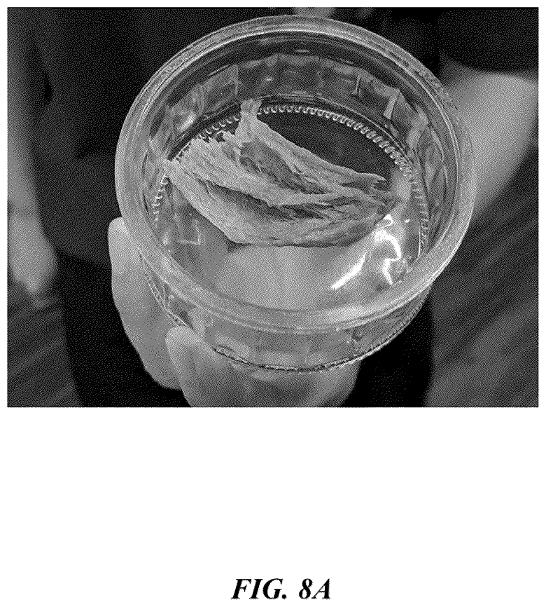

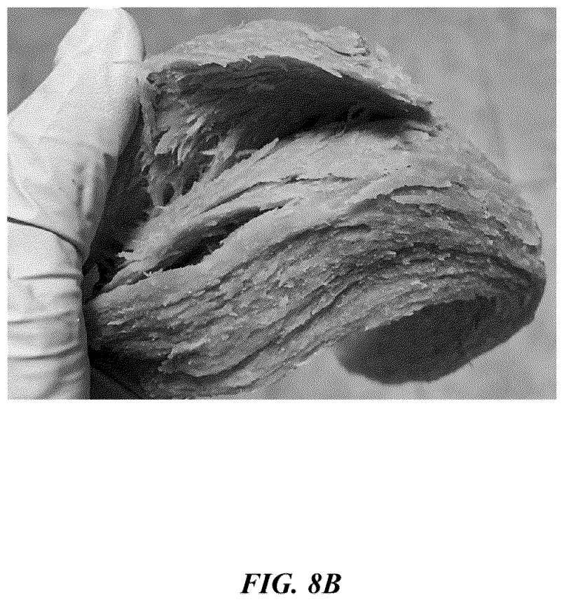

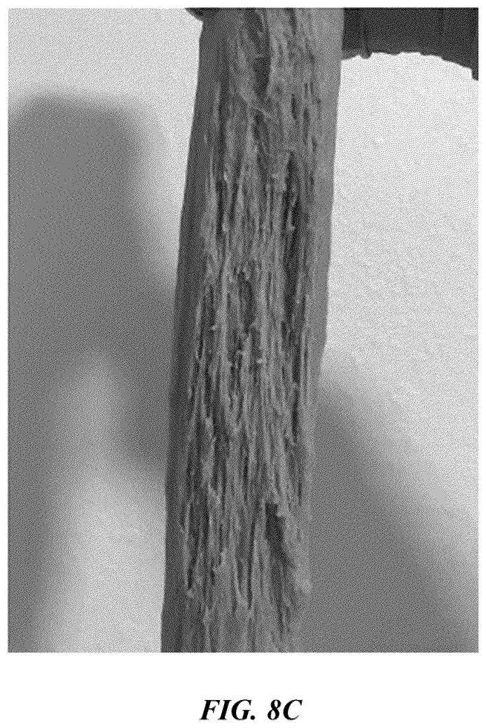

Puree(s) and milk(s) are combined with wheat gluten (e.g., vital wheat gluten) and an oil. The mixture is mixed from about 10 seconds to about 30 mins or until homogenous in a dough mixer or a mixing processor. The resulting mixture, comprising vital wheat gluten, oil, and two or more kinds of legume protein, is then stretched continuously in one direction. This stretching may increase directional fiber formation. The stretched product is steam cooked from about 50° C. to about 150° C. under pressure from about 5 to 30 pounds-per-square-inch (psi) for about 10 minutes to about 60 minutes (FIGS. 8A-8C).

### Example 4: Preparation of Plant-Based Meat

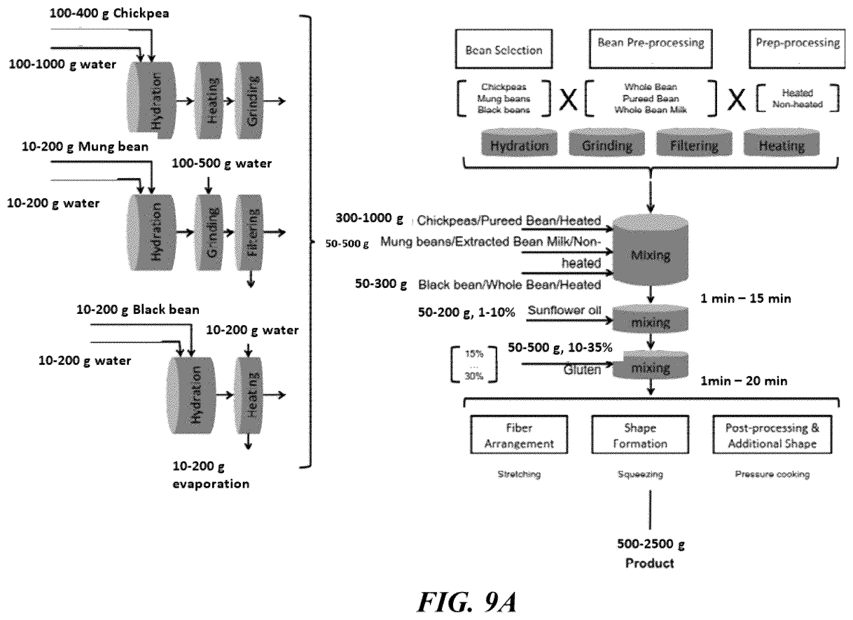

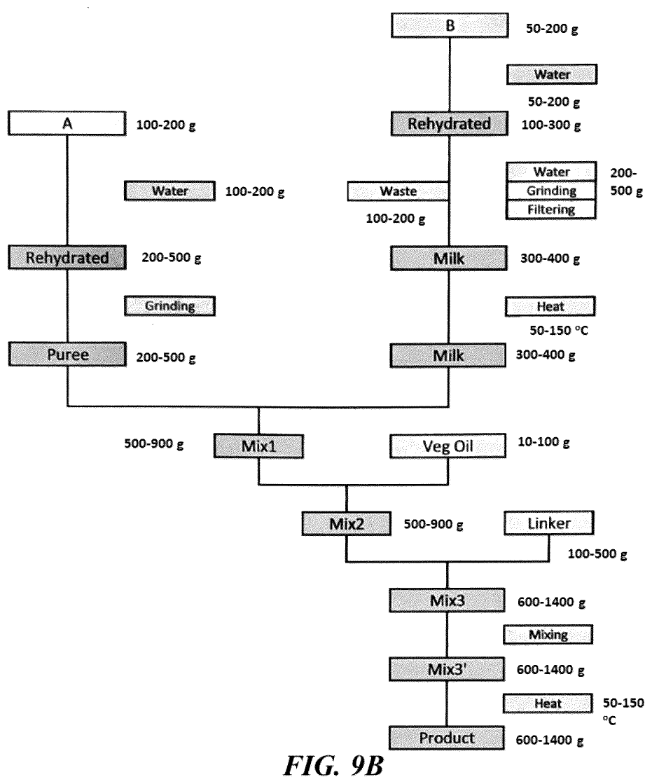

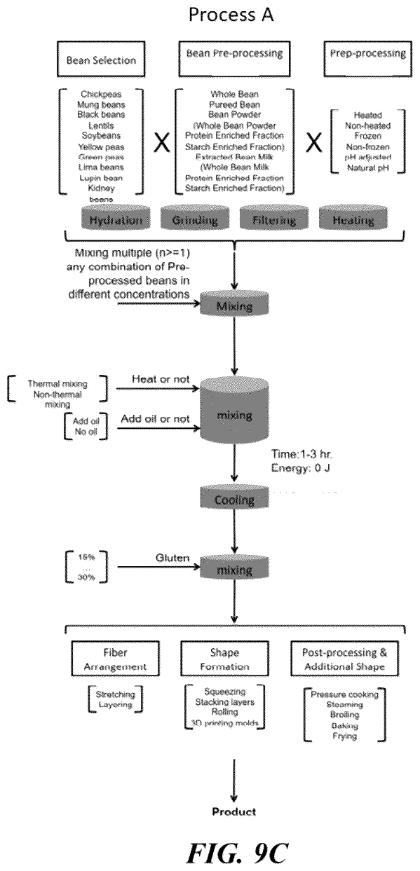

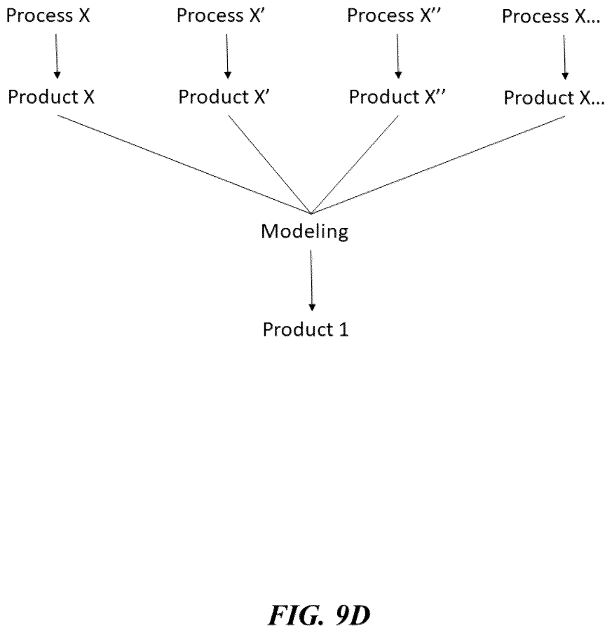

Example processes for preparing a plant-based meat product are schematically depicted in FIG. 9A and FIG. 9B. For example, a process (FIG. 9A) shows an example workflow for producing a plant-based product. The process comprises bean selection (e.g., chickpea, mung bean, black bean, or any other type of bean described herein etc.), bean pre-processing and prep-processing. Bean pre-processing, can include one or more of hydration, grinding and filtering. Prep-processing can include heating or the absence of heating. Such processing can generate bean compositions (e.g., hydrated bean compositions, pureed beans, whole bean milk).

For example, 100-400 g chickpeas are hydrated with 100-1000 g of water. The hydrating mixture is heated and ground to obtain chickpea puree. Alternatively or in addition to chickpeas, 10-200 g mung beans are hydrated with 10-200 g of water. The hydrating mixture is ground in the presence of 100-500 g of water and filtered to obtain mung bean milk. Alternatively to chickpeas or mung beans or in addition to one or both, 10-200 g black beans are hydrated with 10-200 g of water. The hydrated black bean mixture is heated with an additional 10-200 g of water, evaporating 10-200 g of liquid to generate hydrated black beans.

One or more of the hydrated chickpea puree, mung bean milk and hydrated black beans (e.g., 30-1000 g chickpea puree, 50-500 g mung bean milk, 50-300 g hydrated black beans) are then combined with 50-200 g, or 1-10%, oil (e.g., sunflower oil). The mixture is mixed for 1 minute to 15 minutes, and then 50-500 g, or 10-35%, of gluten is added and the mixture further mixed for another 1 minute to 20 minutes. The mixed composition is processed to the plant-based meat product, of about 500-2500 g, by fiber arrangement (e.g., via stretching), shape formation (e.g., via squeezing), or post processing and additional shaping (e.g., via pressure cooking or autoclaving).

An example of legume processing is depicted in FIG. 9B. For example, 100-200 g of dry beans (e.g., bean A) are contacted with 100-200 g of water to generate 200-500 g of rehydrated beans. Rehydrated beans are then subjected to grinding to produce a 200-500 g bean puree. Separately, 50-200 g of dry beans (e.g., bean B) is added to 50-200 g of water to generate 100-300 g of rehydrated beans. Rehydrated beans are then contacted with an additional 200-500 g of water, and the mixture subject to grinding and filtering. 300-400 g of bean B milk is obtained after 100-200 g of waste material is removed. The bean B milk is then heated from about 50-150° C.

The bean puree and the heated bean milk are then combined with The mixture is combined with 10-100 g of vegetable oil and mixed to obtain 500-900 g of a second mixture. The second mixture is then combined with 100-500 g of linker (e.g., gluten) and mixed to obtain 600-1400 g of a third mixture. After mixing, the third mixture is then heated at 50-150° C. to obtain 600-1400 g of plant-based meat product.

General processes for preparing a plant-based meat product are schematically depicted in FIG. 9C and FIG. 9D. For example, Process A (FIG. 9C) shows a general workflow for producing a plant-based product described herein. The process first can include bean selection (e.g., selection of one or more of chickpea, mung bean, black bean, lentils, soy bean, peas, lima bean, lupin bean, kidney bean, etc.). After bean selection, the process can also include bean pre-processing (e.g., to generate one or more of a whole bean mixture, bean puree, bean powder (e.g., whole bean powder, a protein-enriched bean powder, a starch enriched bean powder) extracted bean milk (e.g., whole bean milk, a protein-enriched bean milk, a starch enriched bean milk). Once the beans are pre-processed, the resulting composition can be subjected to post-prep processing, which can include heating or non-heating, freezing or non-freezing, or pH adjustment. Moreover, one or more of bean selection, bean pre-processing, and prep-processing can include one or more of bean hydration, grinding, filtering, and heating.

After, the resulting bean mixture or mixtures may or may not be heated. Oil can then be added, or the mixture can be further processed without oil. The mixture can then be subject to cooling (or not), followed by the addition of gluten (e.g., 15%-30%). The mixed composition is processed to the plant-based meat product by one or more of fiber arrangement (e.g., via stretching or via layering), shape formation (e.g., via squeezing, via stacking layers, via rolling, or via three-dimensional printing, three-dimensional molds), or post-processing and additional shaping (e.g., pressure cooking, steaming, broiling, baking, or frying).

As shown in FIG. 9D, the process shown in FIG. 9C can be repeated any number of times, with the same or differing processing operations, types of beans used, amounts of material used, etc. to produce various products that are analyzed and modeled to generate another product. For instance, Process X is Process A of FIG. 9C, and the other processes (X′, X″, etc.) are different or the same processes as Process A.

### Example 5: Preparation of Plant-Based Coating

Whole yellow peas are soaked for about 1 hour to 24 hours or until the peas are fully hydrated. The hydrated yellow peas are milled with water at a ratio from about 2:1 to about 1:6. The pea milk is extracted by removal of solid matter, including cellulose fibers and plant cell walls. The milk then goes through one or both of two processes: centrifugation at 6-8000 revolutions-per-minute (RPM) for about 1 minute to about 30 minutes or natural settling in a tank for about 1 hour to about 24 hours. The concentration of pea milk is then increased to about 1.1 g per ounce (oz.) to about 5 g per oz. by, for example, reverse osmosis or vacuum operation.

### Example 6: Preparation of Plant-Based Meat Product

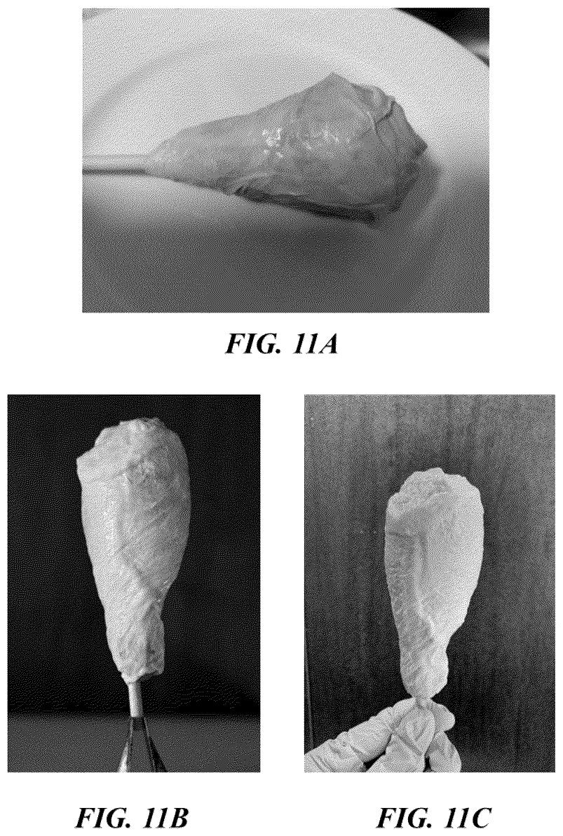

The plant-based meat product may mimic a bone in animal-based meat such as, for example, poultry drumstick, pork or beef rib, or other bone in cut of animal-based meat. To generate the meat in plant-based meat product, pulses are rehydrated by combining with water and refrigerating for 1 to 24 hours. The rehydrated pulses are ground in preparation for forming a dough. Additional dry pulses are ground and undergo air classification to remove particles that are smaller or larger than a select range of particle sizes, for example to concentrate protein. The ground pulses are mixed with protein concentrated, for example via air classification, to form a mixture. The dough is mixed with gluten to form a dough. The dry mixture is combined with the ground rehydrated pulses and an oil to form a dough. The dough is divided and pre-shaped and the bone inserted. In this example, the bone is formed of a wood-based material that is heat treated at a temperature of 50° ° C. to 200° C. at an elevated pressure of about 1 psi to 20 psi for 5 minutes to 1 hour to dry the material. The dried wood-based material is inserted into the pre-shaped dough to act as a bone. The dough and bone are pressure cooked at a temperature between about 50° C. to 200° C. and a pressure from about 1 psi to 20 psi for 5 minutes to 2 hours to form an intermediate plant-based composition. The intermediate plant-based composition may be coated with skin-like material. The skin-like material may be generated by rehydrating dried beans or pulses. The rehydrated beans or pulses may be ground, diluted with water at a 2:1 to 1:6 ratio, filtered, shaped or layered, and heated at a temperature from about 50° ° C. to 200° ° C. to form the skin-like material. The skin-like material is applied to the outer surface of the intermediate plant-based composition to generate a skin coating. The skin coating is dried at a temperature between 1° ° C. and 10° C. FIGS. 11A-11C show an example plant-based meat composition wrapped in a coating.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1-18. (canceled)

19. A legume-based meat dough composition having a three-dimensional structure, the composition comprising:
legume protein held within the three-dimensional structure;
a loosely formed fibrous network comprising fibers or bundles of fibers; and
starch, fat and water incorporated between the fibers or bundles of fibers;
wherein the composition:
(i) has a legume protein content of at least 10% by weight;
(ii) is substantially homogenous; and
(iii) does not include an animal-derived components.

20. The composition of claim 19, wherein the composition is not extruded.

21. The composition of claim 19, wherein the fibers comprise wheat protein.

22. The composition of claim 19, wherein the legume protein content is between 10% and 40% by weight.

23. The composition of claim 19, wherein the composition has a water content between 20% and 60% by weight.

24. The composition of claim 19, wherein the legume protein comprises chickpea protein or soy protein.

25. The composition of claim 19, wherein the fat comprises vegetable oil; the coloring agent comprises turmeric; and the flavoring agent comprises salt, natural flavorings, or a combination thereof.

26. The composition of claim 19, further comprising: at least one coloring agent, flavoring agent, or a combination thereof.

27. The composition of claim 19, wherein the composition consists essentially of:
legume protein held within the three-dimensional structure, wherein the legume protein comprises chickpea protein;
a loosely formed fibrous network comprising fibers or bundles of fibers, wherein the fibers comprise wheat protein;
starch, water and fat incorporated between the fibers or bundles of fibers; and
at least one coloring agent, flavoring agent, or a combination thereof, wherein the composition:
(i) has a water content between 20% and 60% by weight;
(ii) has a legume protein content between 10% and 40% by weight;
(iii) is substantially homogenous;
(iv) does not include an animal-derived components; and
(v) is not extruded.

28. A legume-based meat-structured protein composition having a three-dimensional structure, comprising:
denatured legume protein held within the three-dimensional structure;
substantially aligned fibers or bundles of fibers;
starch, fat and water incorporated between the fibers or bundles of fibers, wherein the composition:
(i) has a legume protein content of at least 10% by weight; and
(ii) does not include animal-derived components.

29. The composition of claim 28, wherein the composition is not extruded.

30. The composition of claim 28, wherein the fibers comprise wheat protein.

31. The composition of claim 28, wherein the fibers comprise glutenins and/or gliadins.

32. The composition of claim 28, wherein the legume protein content is between 10% and 40% by weight.

33. The composition of claim 28, wherein the composition has a water content between 20% and 60% by weight.

34. The composition of claim 28, wherein the legume protein comprises chickpea protein or soy protein.

35. The composition of claim 28, wherein the fat comprises vegetable oil; the coloring agent comprises turmeric; and the flavoring agent comprises salt, natural flavorings, or a combination thereof.

36. The composition of claim 28, further comprising: at least one coloring agent, flavoring agent, or a combination thereof.

37. The composition of claim 28, wherein the composition consists essentially of:
denatured legume protein held within the three-dimensional structure, wherein the legume protein comprises chickpea protein;
substantially aligned fibers or bundles of fibers, wherein the fibers comprise wheat protein;
starch, fat and water incorporated between the fibers or bundles of fibers; and
at least one coloring agent, flavoring agent, or a combination thereof, wherein the composition:
(i) has a water content between 20% and 60% by weight;
(ii) has a legume protein content of at least 10% by weight;
(iii) does not include an animal-derived components; and
(iv) is not extruded.

38. A legume-based meat-structure food composition, comprising:
an inner legume-based meat-structured component surrounded by a crispy outer surface, wherein the inner legume-based meat-structured component comprises the legume-based meat-structured protein composition of claim 28.
